(19) United States
(12) Patent Application Publication
(10) Pub. No.: US 2026/0219954 A1
(43) Pub. Date: Jul. 30, 2026

(54) SELECTIVE MODEL MODIFICATION AND FOR ARTIFICIAL INTELLIGENCE WORKLOADS

(71) Applicant: Dell Products L.P., Round Rock, TX (US)

(72) Inventor: DHARMESH M. PATEL, Round Rock, TX (US)

(21) Appl. No.: 19/036,415

(22) Filed: Jan. 24, 2025

(51) Int. Cl. G06F 9/50; G06F 9/48; G06Q 10/0637

(52) U.S. Cl. CPC G06F 9/5055; G06F 9/4868; G06Q 10/0637

(57) ABSTRACT

Methods, systems, and devices are provided for managing operation of a system. To manage the system, components of an artificial intelligence workflow pipeline may be evaluated for migration, replication, or tuning. If a new model instance is to be instantiated based on the evaluation, a selection process may be performed to identify a host location. The selection process may take into account resource costs for modifying the model for compatibility and useful life estimated for the new instance.

### FIELD

Embodiments disclosed herein relate generally to management of data processing systems. More particularly, embodiments disclosed herein relate to systems and methods for management of artificial intelligence-based systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating systems in accordance with an embodiment.

FIGS. 2A-2C, 2F, and 3A-3D show data flow diagrams illustrating processing of data in accordance with an embodiment.

FIGS. 2D-2E and 2G show block diagrams illustrating hardware systems in accordance with an embodiment.

FIGS. 4A-4E show flow diagrams illustrating methods for managing operation of a system in accordance with an embodiment.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems that may provide, at least in part, computer implemented services. The computer implemented services may be provided to any type and/or number of other devices and/or users of the data processing systems. Furthermore, the provided computer implemented services may be of any quantity and/or type of such services.

As part of the computer implemented services, various artificial intelligence based services may be utilized. To enable artificial intelligence based services to be efficiently provided, potential hardware to support operation of an artificial intelligence based workflow architecture may be analyzed. During the analysis, potential communication bottlenecks may be proactively identified and used as a basis for disqualifying potential hardware.

Consequently, when deployed to selected hardware, the artificial intelligence based services may be less likely to suffer phantom slowdowns or other undesired behavior due to communication bottlenecks that may not be apparent from analysis of the hardware architecture. Accordingly, the disclosed systems may be more likely to provide desired services (e.g., that meet the expectations of users).

Once instantiated, operation of an artificial intelligence workflow pipeline may be monitored. In particular, queues or other parts that may indicate bottlenecking may be monitored. The operation of these components may be compared to historic operation of similar pipelines to identify whether the operation is anomalous, unexpected, undesired, etc. If so identified, then the components of the artificial intelligence workflow pipeline and host hardware may be analyzed to identify communication and/or storage access bottlenecks. If such bottlenecks are identified, a remediation plan may be generated and performed to update operation of the artificial intelligence workflow pipeline so that it is less likely to exhibit that behavior, and is more likely to provide desired computer implemented services.

To generate the remediation plan, alternative locations for components impacted by the bottlenecks may be identified and evaluated. One of the alternative locations may be selected, and may be used in establishing the remediation plan.

In an embodiment, a method for managing operation of a distributed system hosting an artificial intelligence workflow pipeline is disclosed. The method may include making an identification that a new instance of a trained machine learning model is to be added to the distributed system for the artificial intelligence workflow pipeline; identifying potential host locations of the distributed system for the new instance; estimating resource costs for compatibility of the trained machine learning model with the respective potential host locations; estimating a useful life of the new instance; selecting one of the potential host locations based, at least in part, on the resource costs and the useful life; instantiating the new instance of the trained machine learning model to the selected one of the potential host locations to obtain an updated artificial intelligence workflow pipeline; and provisioning desired computer implemented services using the updated artificial intelligence workflow pipeline.

The one of the potential host locations may be selected using, at least in part, an objective function that takes into account the resource costs and the useful life.

The objective function may be usable to rank order the potential host locations.

The objective function may penalize resource costs inversely to the useful life.

The resource costs for compatibility of the trained machine learning model may be based modification costs for the trained machine learning model to be within resource availabilities of the potential host locations.

The modification costs may include resource expenditures for distilling of the trained machine learning model to obtain a reduced size version.

The expenditures may include first resources for generating synthetic training data and second resource costs for training a new machine learning model using, at least, the synthetic training data.

The useful life may be based on historic information regarding durations of time other trained machine learning models that are similar to the trained machine learning model remained in the artificial intelligence workflow pipeline.

The other trained machine learning models may be deemed similar to the trained machine learning model based on a common architecture. In other words, similar in terms of neuron architecture, attention mechanisms, etc. Any basis for comparison may be used, such as, for example, clustering or analytical processes.

The other trained machine learning models may be deemed similar to the trained machine learning model based on a common inference type. In other words, models that generate similar content in output. Any basis for comparison may be used, such as, for example, clustering or analytical processes.

In an embodiment, a non-transitory media is provided. The non-transitory media may include instructions that when executed by a processor cause, at least in part, any of the methods discussed above to be performed.

In an embodiment, a data processing system is provided. The data processing system may include the non-transitory media and a processor and may, at least in part, perform any of the methods discussed above when the computer instructions are executed by the processor.

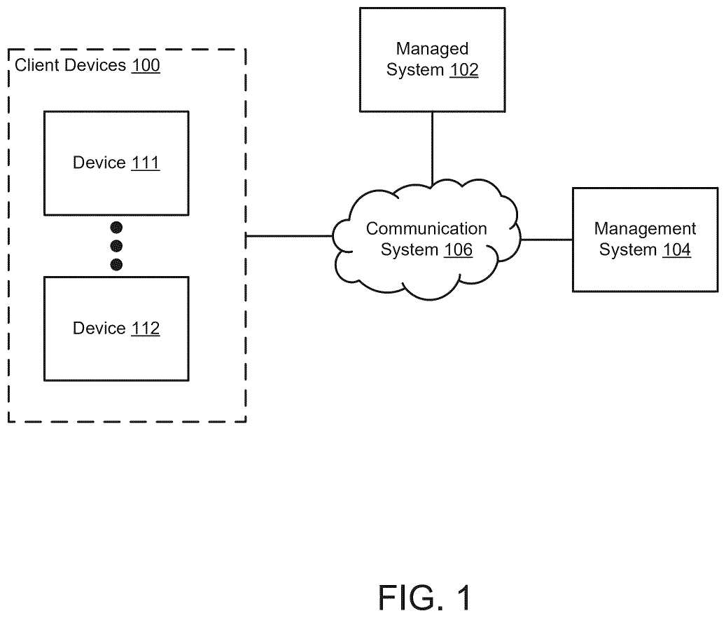

Turning to FIG. 1, a block diagram illustrating a system in accordance with an embodiment is shown. The system shown in FIG. 1 may be a distributed system that provides computer implemented services.

These computer implemented services may include any type and/or quantity of services. The services may include, for example, database services, data processing services, electronic communication services, and/or any other services that may be provided by one or more computing devices. Other types of services may be provided by the system shown in FIG. 1 without departing from embodiments disclosed herein.

When providing these computer implemented services, other types of services (e.g., non-primary services) may be utilized (e.g., by primary services that provide the desired computer implemented services). For example, various artificial intelligence based services (e.g., non-primary services) may be used to provide the desired computer implemented services (e.g., by primary services). The artificial intelligence based services may be provided using, for example, trained machine learning models. The trained machine learning models may be trained to provide inferential, generative, and/or other types of artificial intelligence based services.

In the context of generative services, various prompts may be submitted and processed by the trained machine learning models to generate an output. Depending on the type of the generative services, various other supporting services such as retrieval augmented generation, transfer learning, distillation, reinforced learning, and/or other support services for artificial intelligence services may be used. Consequently, an artificial intelligence based processing architecture (e.g., trained machine learning model and other support services) may vary significantly depending on implementation.

To support operation of the artificial intelligence based processing architectures, various hardware resources may be allocated for use by these artificial intelligence based processing architectures. However, unlike many types of computing processes that may generally benefit from resource scaling (e.g., allocating additional computing resources via any mechanism such as parallelism via instantiating new instances of components of the artificial intelligence based processing architectures), artificial intelligence based processing architectures may present unique resource constraints that may result in unexpected behavior when resource scaling is employed. If the unique resource constraints (or other types of limits) are not met by the resources allocated to the artificial intelligence based processing architectures, then the additionally allocated resources may be used inefficiently and the artificial intelligence based processing architectures may provide poor quality of services. For example, various bottlenecks in the allocated resources may prevent the artificial intelligence based processing architectures from efficiently utilizing the allocated resources. Consequently, significant quantities of allocated resources may go unutilized (or underutilized) because other resources (or lack thereof) may be constraining operation of the artificial intelligence based processing architectures. Thus, artificial intelligence based processing architecture may inefficiently utilize allocated computing resources.

In addition to communication bottlenecks, latency and bandwidth of storage access may have outsized impacts on the quality of artificial intelligence based services. For example, various portions of the artificial intelligence based processing architectures may be performed sequentially. Consequently, storage access induced limits imposed on portions of the artificial intelligence based processing architectures may necessarily impact downstream components in the artificial intelligence based processing architectures. The combination of communication and storage access limits may impact various components of the artificial intelligence based processing architectures, making the root cause of undesired of operation of artificial intelligence based processing architectures difficult to identify and remediate.

Further, when migrating components of artificial intelligence workflow pipelines to address such bottlenecks, potential locations to which the components may be migrated may lack sufficient resources for operating the components. The component sizes and/or resource requirements may be reduced through modification, but such modifications may negatively impact the ability of the migrated components to contribute to the services provided by the artificial intelligence workflow pipelines. Thus, even if impacted components are moved, the operation of the artificial intelligence workflow pipelines may continue to be impaired or otherwise undesirable.

In general, embodiments disclosed herein relate to systems, devices, and methods for managing operation of a distributed system that provides, in part, artificial intelligence based computer implemented services in a manner that improves efficiency of use of allocated resources (e.g., computing resource such as hardware components or logical allocations of resources provided by hardware components such as processing cycles, memory space, storage space, communication bandwidth, special purpose processing cycles, etc., and/or instance based scaling). To manage the operation of the system, hardware components to support services provided by the system may be selected based on artificial intelligence based processing architectures that are expected to be used to provide the services.

To select the hardware components, information regarding expected services to be provided (e.g., a goal description and/or supplemental description) may be collected and analyzed to estimate use levels for the services, support levels for the services, and model levels for the services. The aforementioned information may be analyzed to identify (i) an artificial intelligence based processing architecture and (ii) corresponding hardware components usable to support the identified artificial intelligence based processing architecture.

During the aforementioned analysis, communication requirements between components of the artificial intelligence based processing architecture may be used to screen, filter, and/or otherwise discriminate undesirable hardware components (or entire architectures) from desirable hardware components (or entire architectures). For example, hardware components may be analyzed with respect to communication bottlenecks that are likely to be created between components of artificial intelligence based processing architectures. These bottlenecks (and/or other information regarding communication limits) may be used as a basis for discriminating undesirable from desirable hardware components.

Once the hardware components (e.g., in aggregate a selected architecture) are identified, the identified hardware components may be used to update operation of a system to provide the desired computer implemented services. For example, new hardware components may be added and/or existing hardware components may be repurposed for providing the desired computer implemented services.

To manage operation of the artificial intelligence based processing architectures once deployed, queue length and/or other features of the artificial intelligence based processing architectures (e.g., a deployed instance of an artificial intelligence based processing architecture being referred to as an artificial intelligence workflow pipeline) may be monitored. The monitoring may allow for the identification of undesired operation of artificial intelligence workflow pipelines (e.g., overloading, delays, etc.). When such identifications are made, the artificial intelligence workflow pipelines, host hardware components, and data structures used in operation of the artificial intelligence workflow pipelines may be analyzed to identify (i) communication bottlenecks and/or (ii) data access bottlenecks. When identified, the system may take steps to relax or otherwise mitigate impacts of the bottlenecks. The steps may include, for example, migrating data structures or components of the artificial intelligence workflow pipelines, instantiating new instances of data structures in new locations (e.g., to reduce communication bottlenecks and/or storage access bottlenecks), adding new hardware components, and/or performing other actions that may address the bottlenecks.

When components are selected for migration or replication, a variety of factors may be taken into account when evaluating potential migration/replication locations. The factors may include, for example, reduction in capabilities due to necessary changes in component architectures, computational costs for making such changes, time delays for making such changes, likely improvement in operation of the artificial intelligence workflow pipelines, cost for such modifications, and/or other factors that may impact desirability of various changes to the artificial intelligence workflow pipelines that may be made through replication and/or migration.

To provide the above noted functionality, the system of FIG. 1 may include client devices 100, managed system 102, management system 104, and communication system 106. Each of these is discussed below.

Client devices 100 may include any number of data processing systems such as devices 111 and 112. Devices 111-112 may be, for example, personal computers issued by an organization to an employee, or another type of computing devices. Any of client devices 100 may provide any number and type of computer implemented services to users thereof and/or other devices. As part of providing the services, client devices 100 may utilize services provided by managed system 102. The services may include, for example, artificial intelligence based processing services using artificial intelligence based processing architectures hosted by managed system 102.

Managed system 102 may provide various services to client devices 100 (and/or other devices/entities). To do so, managed system may (i) include hardware and software components corresponding to desired services as indicated by the users (or administrators) of client devices 100, and (ii) host artificial intelligence based processing architectures used to provide, at least in part, the services to client devices 100. Managed system 102 may include any number and type of data processing systems. The data processing systems may independently and/or cooperatively provide various computer implemented services.

Additionally, any of the data processing systems of managed system 102 may host (i) automation frameworks to facilitate changes in operation of managed system 102 as directed by management system 104, (ii) telemetry (or other types of information) reporting systems to provide management system 104 with information regarding the operation of hosted artificial intelligence workflow pipelines, and/or other components to facilitate management of managed system 102 by management system 104.

Management system 104 may manage operation of managed system 102 on behalf of users (or administrators) of client devices 100. To do so, management system 104 may (i) provide a portal or other interface through which users/administrators of client devices 100 may indicate services that are to be provided by managed system 102 (e.g., to client devices 100 and/or other devices not shown in FIG. 1), (ii) select hardware/software components to provide the services (e.g., based on artificial intelligence based processing architectures), (iii) when selecting the components, perform various communication capabilities analysis and reviews to discriminate desirable from undesirable hardware components to support an artificial intelligence based processing architecture, (iv) modify the hardware components (e.g., add/remove/reconfigure/reallocate for use in the identified services) and/or the operation of managed system 102 (e.g., by adding/removing/reconfiguring software components) over time (e.g., based on information from users/administrators of client devices 100 and/or other basis), and/or perform other actions to facilitate provisioning of services by managed system 102.

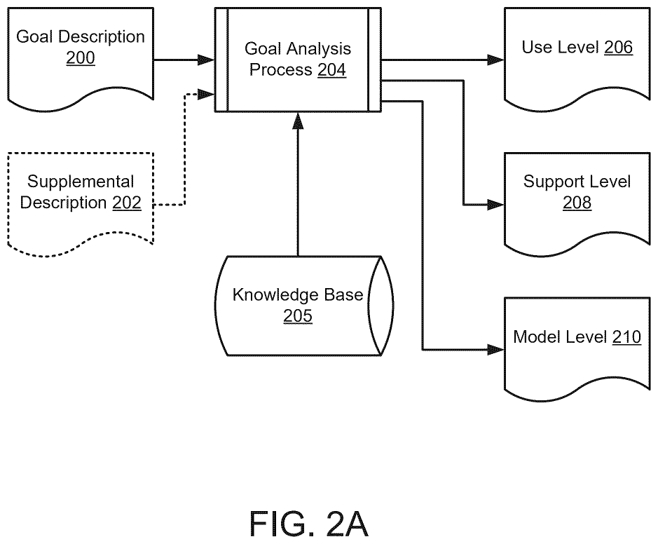

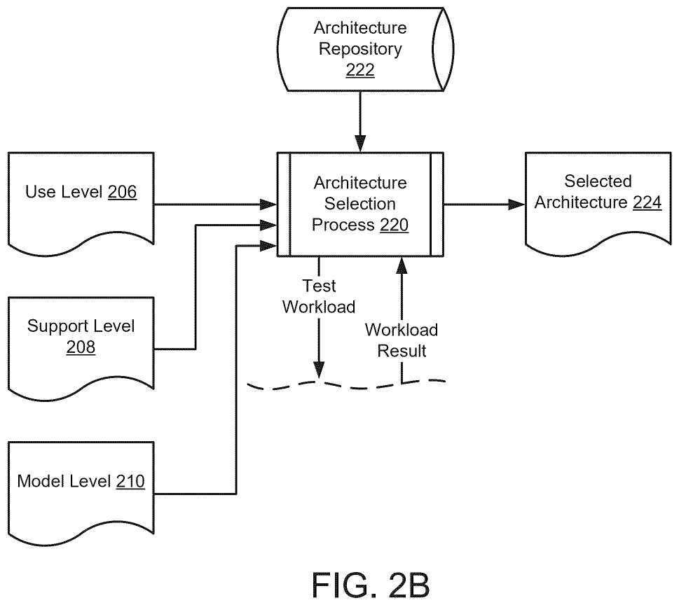

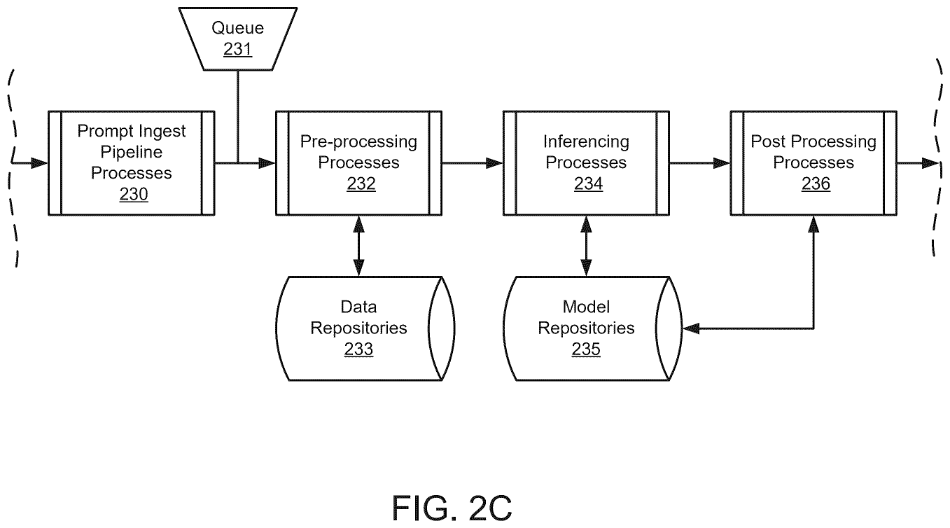

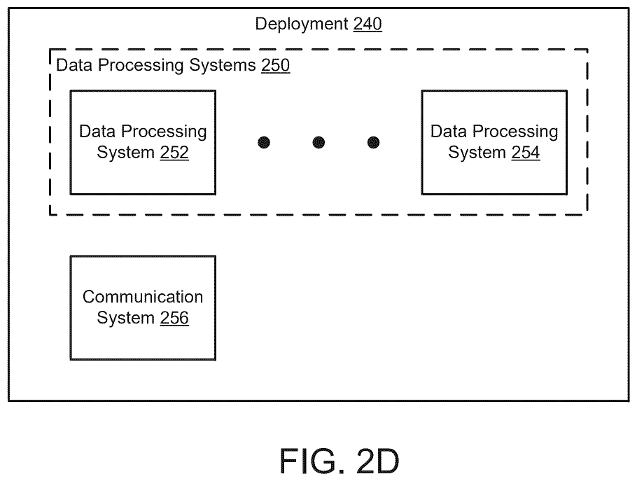

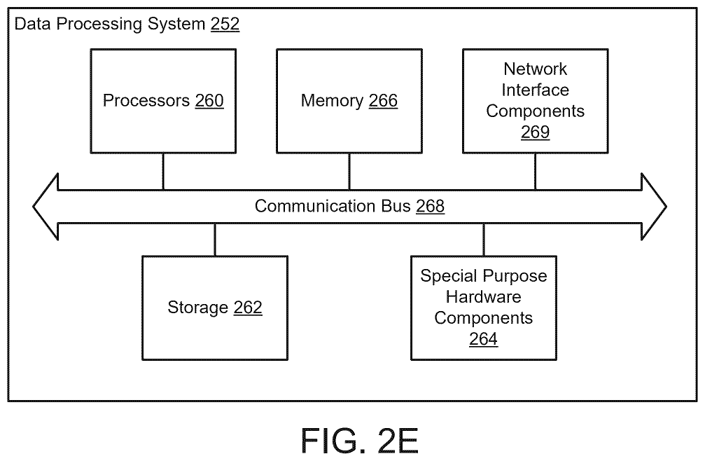

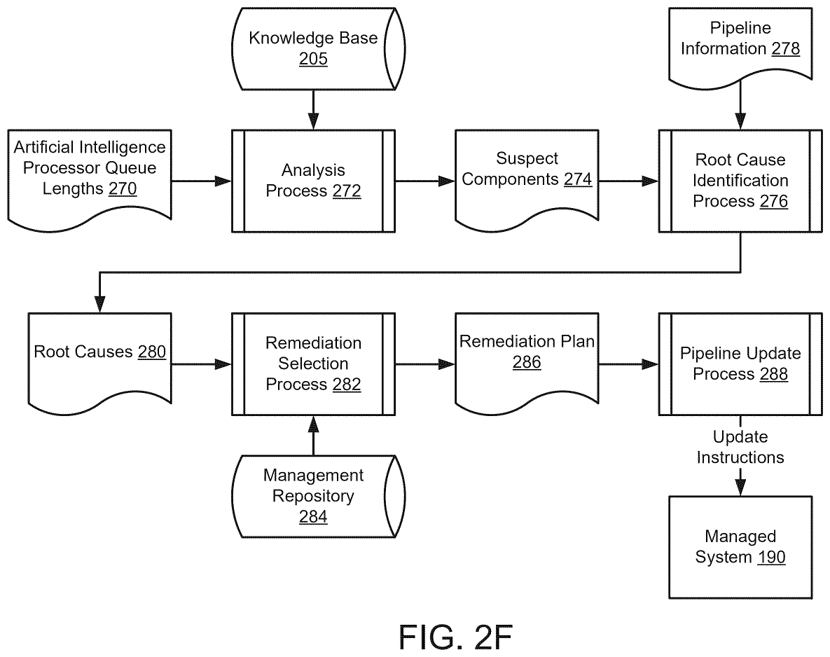

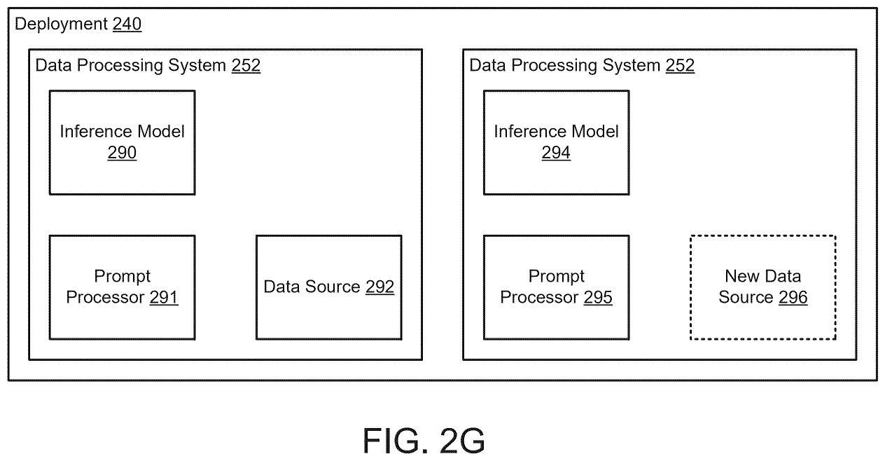

For example, management system 104 may identify a desirable artificial intelligence based processing architecture through which desired computer implemented services may be provided, identify hardware components to support the architecture, and manage deployment of the artificial intelligence based processing architecture and/or hardware components (and/or reallocation of existing components of managed system 102 to the artificial intelligence based processing services) to managed system 102 to instantiate various artificial intelligence workflow pipelines. Refer to FIG. 2D-2E for additional details regarding artificial intelligence based processing architectures and/or how hardware components to support artificial intelligence based processing architectures that may be selected for deployment.

Once the architecture and hardware components are identified and deployed, management system 104 may monitor operation of the deployed distributed system to identify whether it is performing as expected or performing undesirably (e.g., in an undesired state, such as unexpected operation of artificial intelligence workflow pipelines, etc.). To ascertain the state of the system, management system 104 may monitor operation of the hosted artificial intelligence workflow pipelines to obtain performance metrics (e.g., queue lengths for components of the artificial intelligence workflow pipelines, or other information usable to granularly identify performance of different portions of the artificial intelligence workflow pipelines) for the operation. If the performance is identified as undesirable (e.g., excess queue length), then the artificial intelligence workflow pipelines, host hardware components, data structures used in operation of the artificial intelligence workflow pipelines, and/or other information may be collected to perform root cause analysis. Once a root cause is identified, then actions may be performed to remediate the operation of the artificial intelligence workflow pipelines. Refer to FIGS. 2F-2G for additional information regarding management of operation of artificial intelligence workflow pipelines hosted by managed systems.

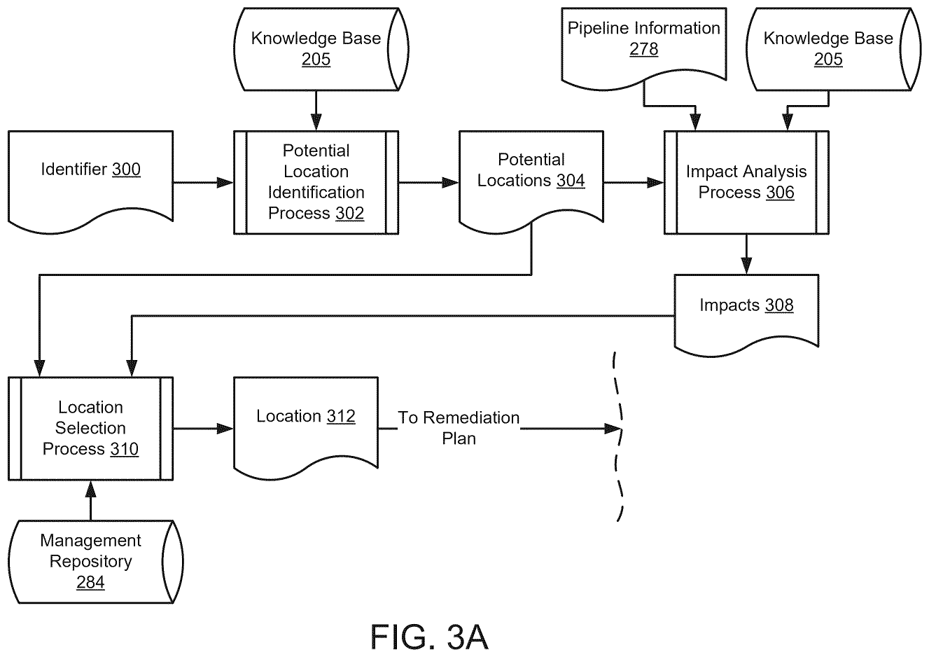

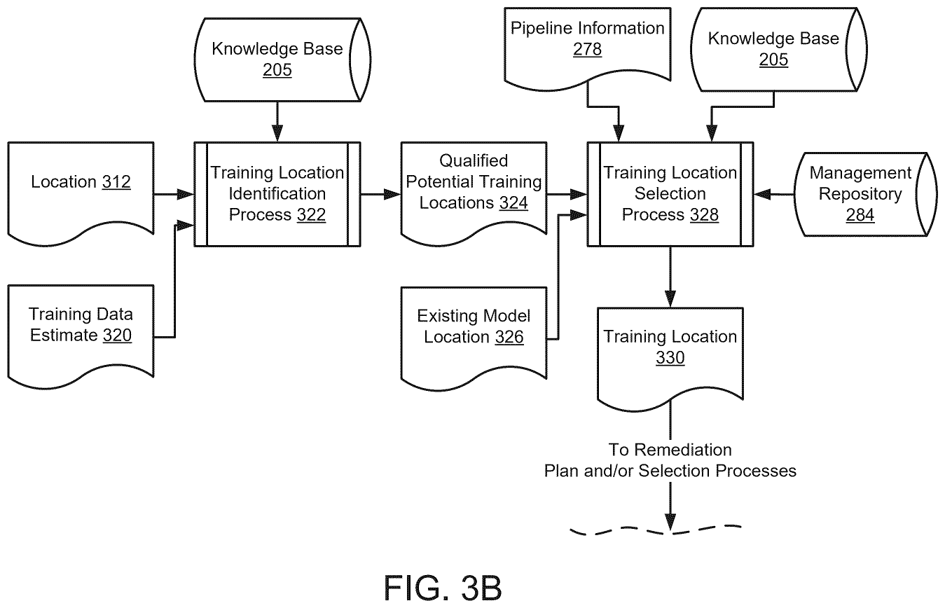

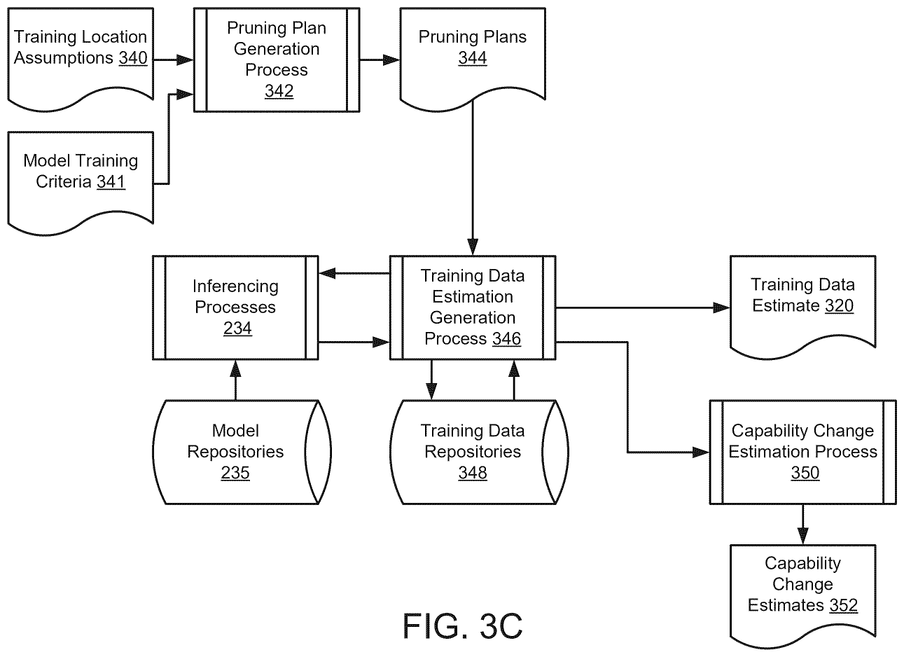

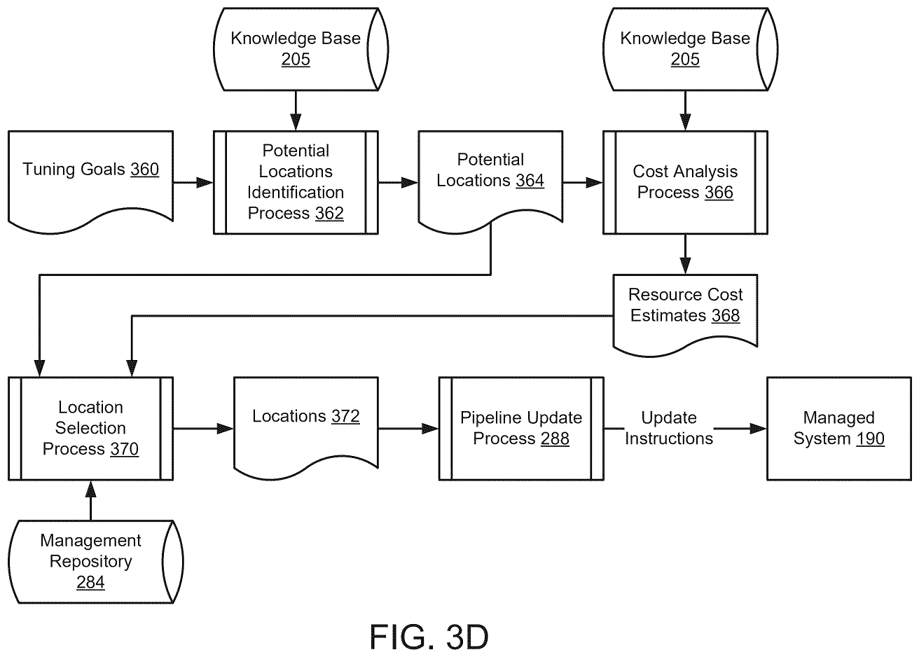

When remediation operations include migration and/or replication, potential locations for the migrated/replicated component may be evaluated. The evaluation may balance, at least, reduction in performance of the components, cost for making such modifications, and benefits provided to the artificial intelligence workflow pipelines due to the modifications to rank the potential locations. The ranked potential locations may then be used as a basis for establishing remediation plans. Refer to FIG. 3A-3D for additional information regarding evaluation of potential migration/replication locations.

When providing their functionality, client devices 100, managed system 102, and/or management system 104 may perform all, or a portion, of the flows and/or methods shown in FIGS. 2A-2C, 2F, and 3A-4E.

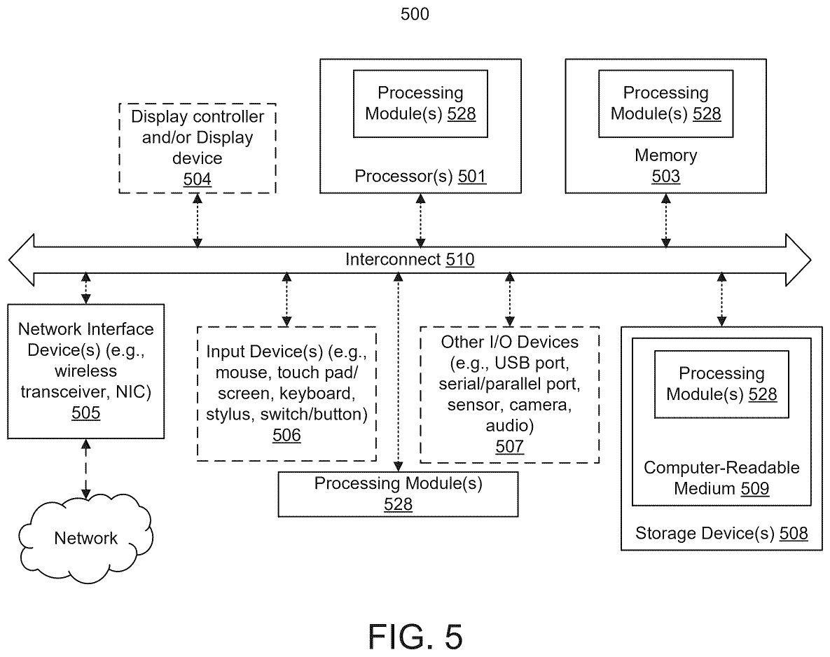

Any devices (and/or components thereof) included in the system of FIG. 1 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 5.

Any of the components illustrated in FIG. 1 may be operably connected to each other (and/or components not illustrated) with a communication system (e.g., 106) utilized by client devices 100, managed system 102, and/or management system 104. In an embodiment, this communication system includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2C, 2F, and 3A-3D. These data flow diagrams may illustrate how data may be obtained and used within the system of FIG. 1.

In the data flow diagrams, flows of data and processing of data are illustrated using different sets of shapes. In the context of these data flow diagrams, a first set of shapes (e.g., 200, 206, etc.) is used to represent data structures, a second set of shapes (e.g., 204, 220, etc.) is used to represent processes performed using and/or that generate data, and a third set of shapes (e.g., 205, 222, etc.) is used to represent large scale data structures such as databases.

Turning to FIG. 2A, a first data flow diagram in accordance with an embodiment is shown. The first data flow diagram may illustrate data used in and data processing performed in providing desired computer implemented services using managed system.

To provide the desired computer implemented services, information regarding desired services may be obtained. The information may take the form of, for example, responses to guided survey questions designed to elucidate desired uses for services to be provided by a managed system. The guided surveys may be presented via the portals, discussed above, and/or via other processes. Various users/administrators of an organization may provide responses via the guided surveys. The resulting aggregated information may be goal description 200.

In addition to goal description 200, other types of information may also be obtained. For example, existing uses of computer implemented services by the organization may be obtained. To do so, (i) information regarding the existing uses may be collected via survey, (ii) observability agents may be deployed to existing systems (e.g., client systems) to collect information regarding uses of existing systems/services, (iii) information regarding the field of operation of the organization may be collected and used as a basis for inferring various goals for desired services (e.g., an inference model such as a trained machine learning model may be used, the model may be trained based on historic information regarding organizations, actual desired uses for the to-be-provided services, and classifications for the organizations such as economic sector, organization size, etc.), and/or other types of information may be collected.

Once obtained, goal description 200 and supplemental description 202 may be ingested by goal analysis process 204. During goal analysis process 204, goal description 200 and/or supplemental description 202 may be analyzed based on knowledge base 205 to identify (i) use level 206, (ii) support level 208, and (iii) model level 210. Knowledge base 205 may include information regarding previously deployed and used artificial intelligence based processing architectures, and corresponding previously obtained goal descriptions and/or supplemental descriptions. Knowledge base 205 may be analyzed to identify a most similar goal description, supplemental description 202, and corresponding artificial intelligence based processing architecture. The corresponding artificial intelligence based processing architecture may be selected for use to provide the desired computer implemented services.

However, it will be appreciated that goal description 200 and supplemental description 202 may be significantly different from previously encountered goal descriptions and supplemental descriptions. In such scenarios, when the difference exceeds a threshold level, a subject matter expert may be used to define the artificial intelligence based processing architecture based on goal description 200 and supplemental description 202. Refer to FIG. 2C for additional information regarding artificial intelligence based processing architectures.

Returning to the discussion of FIG. 2A, once the artificial intelligence based processing architecture (e.g., an artificial intelligence workflow pipeline) is identified, the architecture may be analyzed to identify use level 206, support level 208, and model level 210.

Use level 206 may include information regarding a level of use expected for the artificial intelligence based processing architecture. Use level 206 may be used, for example, to identify how many instances of components of the artificial intelligence based processing architecture are to be instantiated to service the expected load on the service. Use level 206 may be identified, for example, by comparing an expected number of service requests per unit time (e.g., indicated by goal description 200) to typical service requests per unit time that can be achieved by the components of the artificial intelligence based processing architecture when deployed to typical hardware components (e.g., such information may be stored in knowledge base 205, and may be based on historic information from previously deployed artificial intelligence based processing architectures). The number of instances of each of the components may then be stored with use level 206, and used as a basis for analyzing the architectures for potential bottlenecks and/or other features.

Support level 208 may include information regarding services expected to be used to support the artificial intelligence services. The information may include, for example, numbers and types of such services which may include, for example, retrieval augmented generation, distillation, reinforced learning, etc. These services may support the generative or inferential services provided by a trained inference model (e.g., trained machine learning model) by, for example, enhancing prompts (e.g., retrieval augmented generation), customizing/refining models (e.g., reinforced learning, transfer learning, etc.), etc.

Model level 210 may include information regarding the type of model to be used in the artificial intelligence based processing architecture. For example, model level 210 may include information regarding the size of the model, complexity of revising the model, compatibility with other services (e.g., specified by support level 208), features of the architecture of the model (e.g., attention layers/other features), etc.

The aforementioned use level 206, support level 208, and model level 210 may be used to identify a hardware architecture to support the artificial intelligence based processing architecture, as discussed further with respect to FIG. 2B.

Knowledge base 205 may be implemented with a data repository, and may include any type and quantity information regarding any number of previously used artificial intelligence based processing architectures, artificial intelligence (AI) models, correspondingly performance of AI workloads by the models after deployment, information regarding development of the models (e.g., model training where training data is used to define model parameters, inferencing where a model ingests data and generates an output, model updating during which previously defined model parameters are updated based on new training data, etc.), information on which the artificial intelligence based processing architectures and/or models were selected (e.g., such as previously obtained goal descriptions, supplemental descriptions, etc.), and/or other types of information.

To differentiate information regarding the AI models, knowledge base 205 may be organized as, for example, a table including rows, each respective row corresponding to one of the AI models, architectures, and/or other type of structured data.

For example, each row may include information regarding a corresponding AI model, architecture, and/or references to other data structures that include information regarding the corresponding AI models/architectures. Further, the rows may be keyed to facilitate efficient searches for data regarding properties of the corresponding AI model/architecture, and basis (e.g., goal description/supplemental descriptions).

Turning to FIG. 2B, a second data flow diagram in accordance with an embodiment is shown. The second data flow diagram may illustrate data used in and data processing performed in deployment of an artificial intelligence based processing architecture.

To deploy the artificial intelligence based processing architecture, use level 206, support level 208, and model level 210 may be ingested by architecture selection process 220 and through which a selected architecture 224 may be identified. During architecture selection process 220, various hardware components to support the artificial intelligence based processing architecture identified via the flow shown in FIG. 2A may be identified and selected.

To identify and select the components, use level 206 and model level 210 may be used to select a number of candidate hardware components from architecture repository 222. Architecture repository 222 may include information regarding various hardware components that may be used to host an artificial intelligence based processing architecture. Generally, the hardware components may include processors, memory devices, storage devices, special purposes hardware components (e.g., graphics processing units, data processing units, etc.), communication devices (e.g., network interface cards, communication buses, etc.), and/or other types of hardware components (e.g., such as interconnect components like motherboards). Each of the components may be rated in architecture repository 222 with respect to an ability to serve as a host for a component of the artificial intelligence based processing architecture. For example, each hardware component may be rated with respect to the type of component of the artificial intelligence based processing architecture that it may support, the processing capabilities (e.g., throughput), and/or other characteristics that may be used to select a hardware component.

It will be appreciated that architecture repository 222 may include similar information for various aggregations of hardware components such as at a server level, a rack level, an aisle level (e.g., multiple racks), etc. may also be included in architecture repository 222. Thus, in some cases, architecture repository 222 may include information regarding select potential aggregate options.

Based on the information in architecture repository 222, a number of candidate hardware components may be identified to support the artificial intelligence based processing architecture. Refer to FIGS. 2D-2E for additional information regarding hardware components that may support artificial intelligence based processing architectures.

Once the candidate hardware components are identified, the candidate hardware components may be analyzed based on support level 208 to identify (i) placements of components of the artificial intelligence based processing architecture with the candidate hardware components (e.g., may be made based on subject matter expert rules, or other types of rules), and (ii) any communication bottlenecks present in the candidate hardware components that may prevent the corresponding candidate hardware components from providing the processing throughput as indicated by the information in architecture repository 222.

To identify the communication bottlenecks, any process may be performed. For example, subject matter expert rules may be used to analyze the hardware components for such communication bottlenecks, testing of similar hardware components with test workloads may be performed to obtain workload results, etc.

For example, to actively test for communication bottlenecks, test workloads that are representative of the expected use of the artificial intelligence based processing architecture may be deployed to a test hardware setup which may be similar to the candidate hardware components. When deployed, the actual operation of the test workloads may be monitored to identify whether performance of the test workloads meets expectations based on the information included in architecture repository 222. If a deviation from the expected performance is identified, then the candidate hardware component may be removed from consideration. The aforementioned process may be repeated until all deviating hardware components are removed from the candidate hardware components. The remaining candidate hardware components may then be used as a basis for selected architecture 224.

For example, selected architecture 224 may be a list of the numbers and types of the candidate hardware components, the components of the artificial intelligence based processing architecture and placement information with respect to the hardware components, etc. It will be appreciated that selected architecture 224 may include additional, less, and/or different information.

Once selected architecture 224 is obtained, then the artificial intelligence based processing architecture may be deployed to a managed system. As part of the deployment, existing hardware components (that are not yet allocated) of managed system meeting the requirements of selected architecture 224 may be allocated for the artificial intelligence based processing architecture, new hardware components may be added to the managed system, and components of the artificial intelligence based processing architecture may be instantiated on the allocated hardware components of the managed system.

Once instantiated, the artificial intelligence based processing architecture may begin to operate to provide desired computer implemented services. Refer to FIG. 2C for additional information regarding artificial intelligence based processing architectures.

Turning to FIG. 2C, a third data flow diagram in accordance with an embodiment is shown. The third data flow diagram may illustrate data used in and data processing performed in operation of an artificial intelligence based processing architecture.

To operate the artificial intelligence based processing architecture, various components of the artificial intelligence based processing architecture may be deployed to various hardware components allocated for the artificial intelligence based processing architecture to obtain artificial intelligence workflow pipelines (e.g., an example illustrated in FIG. 2C).

For example, the artificial intelligence based processing architecture may include various processes (e.g., 230, 232, 234, 236) for providing artificial intelligence based processing services. However, it will be appreciated that the processes shown in FIG. 2C are just an example and other artificial intelligence based processing architectures may include other types of processes.

Generally, the artificial intelligence based processing architecture may include at least one prompt ingest pipeline processes 230. During prompt ingest pipeline processes 230, prompts for an artificial intelligence model may be obtained and/or partially pre-processed based on various rules for prompts.

Once obtained, the prompts (as processed) may be subjected to various pre-processing processes 232 such as retrieval augmented generation, templating, etc. During such pre-processing processes, information from various data repositories 233 may be obtained and used as context for the prompt. Likewise, various templates for the prompts may be obtained and populated.

It will be appreciated that data repositories 233 may generally be stored in storage, and pre-processing processes 232 may be executing on processors. Depending on the topology of the communication system interconnecting these hardware components, the communication system may limit the ability of the hosted components to efficiently utilize the host hardware components. For example, communication bottlenecks may limit the ability of information to be retrieved from data repositories 233 and vetted for use as context for the prompt, even though neither hardware component hosting the architecture component (e.g., 232, 233) is limiting activity of the hosted architecture component. Likewise, limits on access to data repositories 233 imposed by storage device hosting the repositories may put storage access based limits on operation of pre-processing processes 232. Thus, a first example communication bottleneck that may impact operation of the artificial intelligence based processing architecture is illustrated.

Once pre-processed (e.g., enhanced with contextual information), the prompt (e.g., at least, contextual information and/or other information may also be submitted) may be submitted to inferencing processes 234, and used as an input to a trained model from model repositories 235. The model may be any type of trained machine learning model. Like pre-processing processes 232 and data repositories 233, communication bottlenecks between inferencing processes 234, model repositories 235, and the other components of the artificial intelligence based processing architecture may artificially limit the rate of operation of inferencing processes 234.

Once an inference is obtained based on the prompt, post processing processes 236 may be performed. Post processing processes 236 may include, for example, reinforced learning, rule application (e.g., screening inferences), and/or other processes to obtain a final response to the prompt and/or update operation of the artificial intelligence based processing architecture. Again, like the other components of the artificial intelligence based processing architecture, the throughput of post processing processes 236 may be artificially limited due to communication bottlenecks.

To avoid such limits, the communication capabilities of the candidate hardware components may be analyzed, as discussed above, and serve as a basis for exclusion. To further explain such limits, example diagrams of a potential deployment 240 in accordance with an embodiment are shown in FIGS. 2D-2E, below.

Of course, it will be appreciated that the artificial intelligence workflow pipelines may naturally face various processing workloads that may slow down the artificial intelligence workflow pipelines. To handle such slow downs of components of the artificial intelligence workflow pipelines, various queues (e.g., 231) may be used to manage processing downtime between components of the artificial intelligence workflow pipelines. For example, as prompts are received and pre-processing processes 232 are performed, the prompts may be added to queue 231 for subsequent pre-processing processes 232 which servicing is available.

However, excessive slowdown of some of the components of the artificial intelligence workflow pipelines may indicate that some of the components are being impacted by bottlenecks. For example, queue 231 may have a typical average depth that if exceeded indicates that a communication or storage access bottleneck may be impacting pre-processing processes 232.

As will be discussed below, the depths of the queues may be monitored and used to infer whether various components of the artificial intelligence workflow pipelines are being impacted by unexpected bottlenecks that should be addressed. For example, if data repositories 233 are hosted by a storage device that is creating a bottleneck, then the root of a slow down in operation of the artificial intelligence workflow pipelines may be corresponding identified and remediated.

Turning to FIG. 2F, a fourth data flow diagram in accordance with an embodiment is shown. The fourth data flow diagram may illustrate data used in and data processing performed in managing operation of artificial intelligence workflow pipelines.

To manage the operation, information regarding the operation of artificial intelligence workflow pipelines may be collected from host managed system. For example, the information may include artificial intelligence processor queue lengths 270, which may include information regarding the lengths (and/or other characteristics) of queues for components of the artificial intelligence workflow pipelines. A queue length may be, for example, a number of requests in the queue that have not been processed, a ratio of requests in the queue to a total queue length of the queue (e.g., maximum number of requests), and/or may include additional, less, and/or different information.

Once artificial intelligence processor queue lengths 270 are obtained, analysis process 272 may be performed to identify any number of suspect components 274. During analysis process 272, the queue lengths may be compared to criteria from knowledge base 205. The criteria may be, for example, typical queue lengths (e.g., historic) for corresponding components of artificial intelligence workflow pipelines, acceptable queue lengths (e.g., subject matter expert defined), and/or other basis for comparison. The comparison may be used to identify whether the queues for any number of components indicate that the corresponding components may be being impacted by bottlenecks (e.g., communication, storage access, etc.). Any such identified components may be added to suspect components 274.

Suspect components 274 may then be used during root cause identification process 276 to identify root causes for the bottlenecks. During root cause identification process, pipeline information 278 for suspect components 274 may be obtained. Pipeline information 278 may include information regarding the artificial intelligence workflow pipeline and host hardware components to identify any potential communication bottlenecks and/or storage access bottlenecks. For example, dependencies on communications/storage access by the components of the artificial intelligence workflow pipelines may be analyzed to identify potential issues in the allocated resources.

If an issue is identified, the issue may be identified by issuing test workloads, as discussed with respect to FIG. 2B, to confirm the issue. In the context of an example such as retrieval augmented generation, a databases search to obtain context for prompts may be a bottleneck if the communication to the storage device is saturated or the storage device itself is overworked. To confirm the issue, a test workload may be issued to the host hardware device hosting the retrieval augmented generation program to retrieve data from a storage device that stores the information searched during the retrieval augmented generation process. The process may be monitored (e.g., latency) and information regarding the process may be returned and analyzed in view of historical information for similar components/hardware components to ascertain whether communication, storage access, or other root cause issues are causing the excessive queue length (e.g., any being a root cause).

Once one or more root causes 280 for the suspect components are identified, remediation selection process 282 may be performed to obtain a remediation plan (e.g., 286). During remediation selection process 282, root causes 280 may be analyzed to identify how to remediate them. The remediations for the root causes may include, for example, migration of data structures used by components of artificial intelligence workflow pipelines and/or components of the artificial intelligence workflow pipelines (e.g., to eliminate communication/storage access bottlenecks by moving the components/used data structures), instantiation of new copies of the data structures used by the components of the artificial intelligence workflow pipelines, adding additional computing resources (e.g., via addition/exchange of new hardware components), etc.

To decide on how to remediate the root cause issues, an optimization process may be performed. During the optimization process, various constraints from management repository 284 may be used to ascertain a best fit for remediating the root cause issue. The constraints may, for example, weight various factors in decision making regarding whether to migrate, replicate, add new resources, etc. to address each root cause. In scenarios in which migration or replication is selected, the location for the migration/replication may be identified using the data flow shown in FIGS. 3A-3D, or other processes.

For example, an objective function may be used to evaluate any number of potential ways to remediate each root cause. The objective function may use the constraints to weight or otherwise take into account different aspects of each approach to the remediating each root cause.

For example, management repository 284 may include information for constraints regarding (i) preferences for types of remediation (e.g., data/component migration versus replication), (ii) cost limits for remediations of root causes (e.g., adding new hardware components may have corresponding cost), (iii) balancing impact on other components of the artificial intelligence workflow pipelines against remediating the root causes (e.g., migrating a database used by the pipeline may impact multiple components of the pipeline), (iv) criteria for acceptable versus unacceptable remediation (e.g., the required level of reduction of queue lengths), (v) bandwidth use goals (e.g., may guide in placement) for operation of the artificial intelligence workflow pipelines, and/or other goals for operation of the managed system and hosted artificial intelligence workflow pipelines.

Some of the above constraints may require, for example, information regarding how various remediations are likely to impact operation of the artificial intelligence workflow pipelines. To evaluate the objective function (e.g., to find a remediation deemed best by the criteria) for these constraints, future operation of the artificial intelligence workflow pipelines after various remediations may be simulated using any of (i) analytical models, (ii) digital twins, and/or other simulation components.

To identify potential remediation plans for each root cause, management repository 284 may include information regarding how different types of root causes may be remediated. For each root cause, a potential remediation plan for each way that the root cause may be remediated may be established. These potential remediation plans may then be evaluated (e.g., ranked) using the objective function to identify a best potential remediation plan for each root cause. These remediation plans deemed best by the objective function may then be added to remediation plan 286.

Once remediation plan 286 is obtained, pipeline update process 288 may be performed. During pipeline update process 288, remediation plan 286 may be performed. To perform the plan, various update instructions may be sent to the automation framework of one or more managed systems (e.g., 190) hosting portions of the artificial intelligence workflow pipeline. These instructions may cause, for example, components of the artificial intelligence workflow pipeline to be migrated, components of the artificial intelligence workflow pipeline to be replicated, data structures used by the artificial intelligence workflow pipeline to be migrated and/or replicated, new hardware components to be added to managed system 190 (and/or migration/instantiation of new components/data structures on the new hardware components), etc.

Once the remediation plan is completed, the operation of the artificial intelligence workflow pipeline hosted by managed system 190 may continue to be monitored as discussed with respect to analysis process 272.

For example, turning to FIG. 2G a diagram of deployment 240 in accordance with an embodiment is shown. Deployment 240 may include data processing systems 252-254 which may host components of an artificial intelligence workflow pipeline.

The components may include inference models (e.g., 290, 294), prompt processors (e.g., 291, 295), and a data source 292 (e.g., a retrieval augmented generation database) used by the prompt processors. The components may cooperatively provide artificial intelligence services by (i) obtaining prompts, (ii) obtaining contextual information for the prompts from data source 292, and (iii) using the prompts and contextual information as ingest to the inference models to obtain responses. The responses may be used to provide desired computer implemented services.

As illustrated in FIG. 2G, initially, the artificial intelligence workflow pipeline may only include a single instance of data source 292 (e.g., based on historical data that suggested that a single instance is sufficient). However, now consider a scenario where data processing system 252 and data processing system 254 are operably connected by a poorly performing communication system. Consequently, use of data source 292 by prompt processor 295 may be impeded by the poor connectivity thereby slowing the processing of prompts for contextual information enhancement.

Using the data flow discussed with respect to FIG. 2G, analysis of the queue for prompt processor 295 may indicate that there is an issue impacting prompt processor 295. Based on the identification, a test workload may be deployed and may reveal the poor performance of obtaining data from data source 292, identifying lack of access to data source 292 as a root cause of undesired operation of the artificial intelligence workflow pipeline.

Based on the identification, potential remediations may be identified and may include, for example, migrating prompt processor 295 to data processing system 252, migrating data source 292 to data processing system 254, and replicating data source 292. To select one of the potential remediations, an objective function may be used based on criteria supplied by a manager/operator of deployment 240. In this example, the criteria and objective function may indicate that replication of data source 292 is most likely to successfully resolve the root cause. However, it will be appreciated that other potential remediations such as replication/migration of data source 292 to other data processing systems may also be considered, and may be selected should the criteria provided by the operator warrant such selection (e.g., in this example, the criteria may heavily weight performance and may be cost/resource insensitive).

Based on the selection, the remediation may be performed which may replicate data source 292 as new data source 296 (drawn in dashing to indicate that it may not always be present in this example). Once replicated, prompt processor 295 may be directed to use the replicated copy of data source 292 rather than data source 292, thereby mitigating the root cause of the poor performance of the artificial intelligence workflow pipeline.

Accordingly, the artificial intelligence workflow pipeline may begin to operate in a desirable manner. It will be appreciated that other types of remediation operations such as resource allocation through scaling of instances of prompt processor 295 were unlikely to address the root cause. Thus, the disclosed systems and methods may provide a system that is better able to provide desired computer implemented services by identifying root causes of issues that conventional approaches to manage (e.g., resource scaling) are unlikely to address.

Turning to FIG. 3A, a fifth data flow diagram in accordance with an embodiment is shown. The fifth data flow diagram may illustrate data used in and data processing performed in selecting of locations for remediation plans.

To select locations for migration/replication, an identifier (e.g., 300) of a component identified using the flow shown in FIG. 2F as being impacted by a bottleneck may be obtained. The identifier may be, for example, an identifier of a trained machine learning model, database component, pre-processor, or other component of an artificial intelligence workflow pipeline.

Once identifier 300 is obtained, potential location identification process 302 may be performed. During potential location identification process 302, potential locations for migration/replication of the component within a distributed system may be identified. The identification may be made using information from knowledge base 205. For example, knowledge base may include general information regarding (i) requirements for operation of the component, (ii) modifications that may be made to the component to change the requirements (e.g., reduce), and/or other information usable to discriminate various locations in the distributed system. Once the information is obtained, any number of potential locations 304 (e.g., that may be capable of hosting the component or a reduced version of the component) may be identified (e.g., by comparing available resources at the location to the required resources for the component/reduced version).

To evaluate potential locations 304, impact analysis process 306 may be performed. During impact analysis process 306, impacts 308 on the components due to changes that may need to be made with respect to each of potential locations 304 may be identified. For example, reduction in capabilities (e.g., information loss leading to lower accuracy inferences, search results, etc.) of the component may be estimated during impact analysis process 306.

To ascertain the impact of the changes to the components on the artificial intelligence workflow pipeline, pipeline information 278 and/or knowledge base 205 may be queries to establish simulations (e.g., a digital twin or other tools for estimation) of the operation of the as-modified by the changes pipeline and corresponding potential locations. The simulation may be used, for example, to estimate (i) benefits to the artificial intelligence workflow pipeline (e.g., reduce bottlenecks), (ii) reduction in capabilities of the components and/or artificial intelligence workflow pipeline, and/or other characteristics of operation of the artificial intelligence workflow pipeline and/or impacts on downstream users (e.g., consumers of inferences) of the artificial intelligence workflow pipeline.

Once impacts 308 are obtained, location selection process 310 may be performed. During location selection process 310, impacts 308 and/or other information may be used to evaluate each of potential locations 304 to selection location 312 (e.g., the location for migration/replication). During location selection process 310, an optimization or other process may be used to balance various factors in selecting location 312 from potential locations 304. For example, any amount of information from management repository 284 (e.g., constraints) may be used as part of an optimization of an objective function to (i) rank order potential locations 304 and select a best ranked potential location. As discussed above with respect to 2F, an objective function may be used to establish quantifications for potential locations 304 thereby establishing a rank order.

In addition to impacts, the potential useful life of the new trained machine learning model instance may also be taken into account. For example, the objective function may penalize more significant trained machine learning model changes inversely to the estimated useful life of the trained machine learning model. In other words, expenditures of resources for modifying models for compatibility for shorter lived models may be discouraged by the objective function.

Once location 312 is obtained, the flow may return to FIG. 2F where location 312 may be used to establish a remediation plan (or portion thereof). The remediation plan may then, as discussed with respect to FIG. 2F, be used to address the root cause of issues impacting the operation of the component.

As an example of the optimization process in selecting location 312, the optimization process may use an objective function that ingests any of (i) improvements or impairments to the operation of the artificial intelligence workflow pipeline due to the change in the component, (ii) loss of fidelity or accuracy of the component (e.g., information loss, may be evaluated using any method), (iii) cost (e.g., financial/computation) of modifying the component, (iv) time delay in modifying the component, (v) changes in latency of components of the artificial intelligence workflow pipeline due to placement of the migrated/replicated component, and/or other factors.

By using any of the above factors in the evaluation, advantages and disadvantages of each of the potential locations may be taken into account to select the replication/migration location. Due to the number of potential locations, data used in the evaluations, simulation and potential test workload deployments for the evaluation, the aforementioned evaluation process may be implemented in an automated fashion to make the process tractable, much like training of a machine learning model.

Turning to FIG. 3B, a sixth data flow diagram in accordance with an embodiment is shown. The sixth data flow diagram may illustrate data used in and data processing performed in selecting of locations for remediation plans.

As discussed with respect to impact analysis process 306, in some cases, a pipeline component may need to be modified to operate at one or more locations. For example, the component (e.g., a trained machine learning model) may need to be reduced in size to be able to run at a particular location (e.g., the location may lack hardware/resources capable of hosting larger components).

In such scenarios, model changes may need to be made to the model through, for example, distillation or other processes through which reduced size versions of models may be obtained. However, such processes may be computationally expensive and may have significant impacts on operation of the system. To make migration decisions, locations (e.g., support locations) to perform such operations may be evaluated and taken into account when selecting how to migrate or otherwise manage the pipeline (e.g., due to a component of the pipeline being impaired at a current host location).

To select such locations (e.g., support locations) for modifying pipeline components, training location identification process 322 may be performed. During training location identification process 322, potential training locations 324 (e.g., support locations) for performance of processes to modify existing models for a target migration location (e.g., 312) for an existing component may be identified. During training location identification process 322, information regarding an amount of training data (e.g., 320) needed to be used in performing the processes may be obtained. For example, training data estimate 320 may be based on an amount of synthetic data needed to train a new model that is compatible with the migration location (e.g., small enough to be ran at the migration location).

The synthetic data estimate may be obtained via any process. For example, the synthetic data for the training process to obtain the new model may include (i) samples of the input range of the existing model that is impaired due to its current location, and (ii) inferences generated by the existing model for the samples. The discretization of the sampling may be established via any method to meet various criteria such as, for example, accuracy/fidelity/input range goals for the new model (e.g., higher accuracy/fidelity/input range may require more synthetic data for training). It will be appreciated that any amount of the training data on which the existing model is based may also be used in training of the new model. Thus, training data estimate 320 may be based on the amount of training data (synthetic or existing) to train the new model to meet the criteria.

Training data estimate 320 may then be used to filter knowledge base 205 to identify any number of locations able to support training of the new model (e.g., while meeting certain criteria, such as a maximum allowable training time). The filtered locations may be potential training locations 324. These may be similar or different from location 312. In other words, the potential training locations may be different from the migration location.

Once the potential training locations 324 are obtained, training location selection process 328 may be performed to identify a target training location (e.g., 330).

During training location selection process 328, existing model location 326 and/or other information may be used to evaluate each of potential training locations 324 to select training location 330 (e.g., the location for training). During training location selection process 328, an optimization or other process may be used to balance various factors in selecting training location 330 from potential training locations 324. For example, any amount of information from management repository 284 (e.g., constraints), knowledge base 205, pipeline information 278, and/or other sources of information may be used as part of an optimization of an objective function to (i) rank order potential training locations 324 and (ii) select a best ranked potential training location as training location 330. As discussed above with respect to 2F, an objective function may be used to establish quantifications for potential locations 304, and a similar objective function may be used to establish quantifications for potential training locations 324 thereby establishing a rank order.

Once training location 330 is obtained, the flow may return to FIG. 2F where training location 330 may be used to establish a remediation plan (or portion thereof). The remediation plan may then, as discussed with respect to FIG. 2F, be used to address the root cause of issues impacting the operation of the component. It will be appreciated that training location 330 may also be used, for example, in location selection process 310. For example, the objective function used in selection of location 312 may take into account resource cost for migration of a newly trained model from the support location (e.g., 330) to any of potential locations 304. Thus, the flows shown in FIGS. 3A-3B may be (i) iteratively performed until location 312 and training location 330 have converged (e.g., because location selection processes 310 and 328 may depend on each other) or (ii) performed in parallel (e.g., the optimization functions used in location selection processes 310 and 328 may be co-optimized).

As an example of the optimization process in selecting training location 330, the optimization process may use an objective function that ingests any of (i) duration of time for training, (ii) cost (e.g., financial/computation/time) of training (may take into account existing workloads at the location impacting resource availability, reducing in capabilities of the training location due to the performance of the training at the training location if selected), (iii) resource/time cost for transmitting the synthetic data from a generation location (e.g., existing model location 326, where the existing model is located) to a training location, (iv) resource/time cost for transmitting the newly trained model from the training location (e.g., one of potential training locations 324) to location 312, (v) changes in latency of components of the artificial intelligence workflow pipeline due to placement of the migrated/replicated component, and/or other factors.

By using any of the above factors in the evaluation, advantages and disadvantages of each of the potential locations may be taken into account to select the replication/migration location. Due to the number of potential locations for both training and migration, data used in the evaluations, simulation and potential test workload deployments for the evaluation, the aforementioned evaluation process may be implemented in an automated fashion to make the process tractable, much like training of a machine learning model. For example, the quantification based approach disclosed herein may take into account factors that may not be able to be evaluated by administrators or other persons, and/or evaluated in a consistent manner by such persons.

Turning to FIG. 3C, a seventh data flow diagram in accordance with an embodiment is shown. The seventh data flow diagram may illustrate data used in and data processing performed in estimating training data requirements for generating new trained machine learning models that may be able to be operated at various locations in a distributed system.

To train new inference models that may be compatible with various locations within a distributed system, training data (e.g., synthetic) may be obtained as discussed with respect to FIG. 3B. However, the locations where the training may be performed may be limited, for example, based on existing resources of the locations (e.g., support locations). Thus, different support locations may only be capable of providing for training of corresponding amounts of training data (e.g., while meeting various model training criteria 341, such as a maximum allowable time for completion of the training, a resulting accuracy of a model, etc.).

To facilitate training at various support locations within a distributed system, pruning plans 344 may be developed via pruning plan generation process 342. During pruning plan generation process 342, various training location assumptions 340 may be made. These training location assumptions 340 may include different assumptions regarding a quantity of training data that may be used in corresponding support locations while meeting the model training criteria. For example, the training locations assumptions may include assumptions that one million feature-value relationships may be used to train, five million feature-value relationships may be used to train, etc.

For each set of assumptions in training location assumptions 340, a corresponding pruning plan of pruning plans 344 may be created. Each pruning plan may specify how a set of training data (e.g., synthetic) is to be pruned (e.g., reduced) to meet limits for corresponding support locations. For example, if a trained generative machine learning model is to be distilled, a synthetic training data set may first be generated. The pruning plans may then be applied to the synthetic training data set to generate reduced training data sets that are compatible with corresponding support locations (e.g., the reduced training data sets being of sizes that are capable of being used by the support locations for training purposes based on corresponding amounts of available resources).

The pruning plans may be generated using rules, templates, or other methods for creating pruning plans. The resulting pruning plans may specify (i) how to select portions of training data for removal (e.g., random/targeted sampling), (ii) portions of training data to be preferred (e.g., may be selected based on historic operation of the trained generative machine learning model to align the reduced training data with examples of historic input to the trained generative machine learning model), and/or other actions for reducing the data.

Once the pruning plans are obtained, training data estimation generation process 346 may be performed to obtain training data estimates 320. Training data estimates 320 may include estimated amounts of training data for different training location assumptions. As discussed with respect to FIG. 3B, training data estimates 320 may be used to qualify different locations as potential support locations (e.g., provisional). The potential support locations may be filtered based on, for example, reductions in capability of new trained generative machine learning models that are likely to be obtained using the reduced amount of training data that the respective potential support locations are able to use in training. The potential support locations may then be filtered based on, for example, these reduced capabilities (e.g., whether model training criteria 341 is met) to identify qualified potential training locations (e.g., qualified potential training locations 324) which may be evaluated during training location selection process 328.

To obtain training data estimate 320, a synthetic training data set may be generated (e.g., using inferencing processes 234 that may be running instances of the trained generative machine learning model that is to be migrated and/or training data repositories 348 which may include the training data upon which the trained generative machine learning model is based). The synthetic training data set may be generated via any method (e.g., any sampling process).

Once obtained, pruning plans 344 may be applied to identify corresponding reduced training data sets usable by different support locations. The reduced training data sets may be characterized (e.g., quantity, file sizes, etc.) and the characterizations may be stored as training data estimate 320.

Additionally, the reduced training data sets may be used in capability change estimation process 350. During capability change estimation process 350, the likely changes in capabilities from the trained generative machine learning model from which the synthetic data is obtained may be estimated and stored as capability change estimates 352. Any estimation process may be used to obtain capability change estimates.

The capability change estimates 352 may be used during training location selection process 328 to select one of the qualified potential training locations 324 (e.g., the object function may take into account changes in performance when quantifying relative values of the respective qualified potential training locations).

Turning to FIG. 3D, a seventh data flow diagram in accordance with an embodiment is shown. The seventh data flow diagram may illustrate data used in and data processing performed in managing operation of an artificial intelligence workflow pipeline.

As discussed with respect to FIG. 2F, components of a workflow pipeline may become impaired due to inoperability or undesirable slow operability. However, in some cases, the components may become impaired because they may fail to provide desired inferences to all downstream consumers. For example, some downstream consumers may identify that other types of information may be more valuable than that provided by the workflow pipeline.

In such circumstances, operation of the workflow pipeline and the downstream users of the inferences may be misaligned. To address the alignment, model tuning may be performed. Model tuning may use an existing model to rapidly train a new model usable to provide inferences of a type that are more desired by a downstream consumer.

Returning to the discussion of FIG. 3D, tuning goals 360 may be obtained when such misalignments are identified. The tuning goals may specify types of models that may be added to the workflow pipeline to provide more desirable inferences. For example, tuning goals 360 may be obtained based on feedback from downstream users of the pipeline.

Once obtained, potential locations identification process 362 may be performed. During potential locations identification process 362, the distributed system may be analyzed (e.g., using knowledge base 205) to identify any locations (e.g., a first set) that are able to host model tuning processes (e.g., may require access to certain resources used in training), and identify any locations (e.g., a second set) that are able to host instances of tuned trained machine learning models (e.g., may require other resources than those used in training).

The resulting potential locations 364 may include sets of locations that have been qualified for both model tuning and hosting running model instances of subsequently tuned models.

Once potential locations 364 are obtained, cost analysis process 366 may be performed to estimate resource costs for performing training and/or inferencing at the locations of potential locations 364. The resulting resource cost estimates 368 may include (i) for each potential training location, resource estimates for transmitting both a base model and tuning training data to the respective training location, and (ii) for each potential deployment location for tuned models, resource estimates for transmitting the tuned model from the training locations to the deployment locations.

The resource cost estimates for the model/training data movement may be estimated using analytical formulas (e.g., based on current locations of the data, network connectivity, etc.), historic information, and/or other estimation basis.

Once resource cost estimates 368 are obtained, location selection process 370 may be performed. During location selection process 370, an optimization process may be performed to select a tuning location and deployment location. The optimization process may use an objective function, as discussed with respect to FIGS. 2F-3D. The objective function may attempt to reduce resource cost in selection of the tuning and deployment locations.

Through the optimization process, locations 372 may be obtained. Locations 372 may be locations in the distributed system for tuning and deploying a tuned trained machine learning model.

Once obtained, locations 372 may be used in pipeline update process 288 to update operation of managed system 190. For example, update instructions may be generated to cause the tuning and deploying to be completed with respect to locations 372.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the data flows may be used to manage various systems components. Turning to FIG. 2D, a block diagram of an example deployment 240 in accordance with an embodiment is shown. Deployment 240 may be a generalized diagram of the same deployment illustrated in FIG. 2G. Deployment 240 may include any number of data processing systems 250. The data processing systems (e.g., 252, 254) may be connected to each other via communication system 256.

Data processing systems 250 may include hardware components that may host components of an artificial intelligence based processing architecture. Refer to FIG. 2E for additional details regarding potential hardware components of a data processing system.

Data processing systems 250 may be operably connected via communication system 256. Communication system 256 may include various communication components such as a switches, routers, etc. These communication components may enable the data processing systems to communicate with one another. Because the artificial intelligence based processing architecture may be distributed across data processing system 250, the communication limits imposed by communication system 256 may limit operation of the hardware components of data processing systems 250 supporting the artificial intelligence based processing architecture.

For example, if some data processing systems (e.g., 254) serve as storage repositories for retrieval augmented generation, but other data processing systems (e.g., 252) process prompts, then the ability of information necessary to provide context for the prompts to be collected may be by communication system 256 rather than the data processing systems themselves. Accordingly, as described, inter-device communication limits may prevent expected operation of artificial intelligence based processing architectures for the given available hardware components.

Turning to FIG. 2E, a block diagram of an example data processing system 252 in accordance with an embodiment is shown. Any of data processing systems 250 may be similar to data processing system 252.

To support operation of the artificial intelligence based processing architecture, data processing system 252 may include various hardware components such as processors 260 (e.g., central processing units), storage 262 (e.g., storage devices, controllers, etc.), memory 266 (e.g., memory modules, transitory), and special purpose hardware components 264 (e.g., graphics/data processing units). The hardware components may be operably connected to each other via a communication bus (e.g., 268), point to point communication links, and/or other communication architectures. Additionally, the hardware components may include a network interface component (e.g., 269, a network interface card, etc.) to enable communications to be routed to other data processing systems.

To support the artificial intelligence based processing architecture, various components of the artificial intelligence based processing architecture may be hosted by the hardware components. For example, trained machine learning models, training programs, etc. may be hosted by special purpose hardware components 264, while processors 260 may host various pre and post processing components of the artificial intelligence based processing architecture. Likewise, storage 262 may host various data structures (e.g., repositories of information) used in the processing such as trained machine learning model copies, repositories of contextual information for prompt enhancement, etc.

The operation of any of these hardware components may be limited due to the communication components supporting their operation. For example, if processors 260 host a pre-processing components such as a retrieval augmented generation process that utilizes contextual information hosted by storage 262, communication bus 268 may limit the rate at which the information may be retrieved should the communication bus be saturated with other traffic (e.g., such as when loading trained machine learning models into special purpose hardware components, transferring context information to other data processing systems, etc.). Accordingly, as described, intra-device communication limits may prevent expected operation of artificial intelligence based processing architectures for the given available hardware components.

To manage these limits, as discussed above, hardware components may be selected, at least, on this basis to prevent them from negatively impacting operation of the artificial intelligence based processing architecture.

While illustrated in FIG. 2E with an example set of hardware components, a data processing system may include fewer, different, and/or additional hardware components without departing from embodiments disclosed herein.

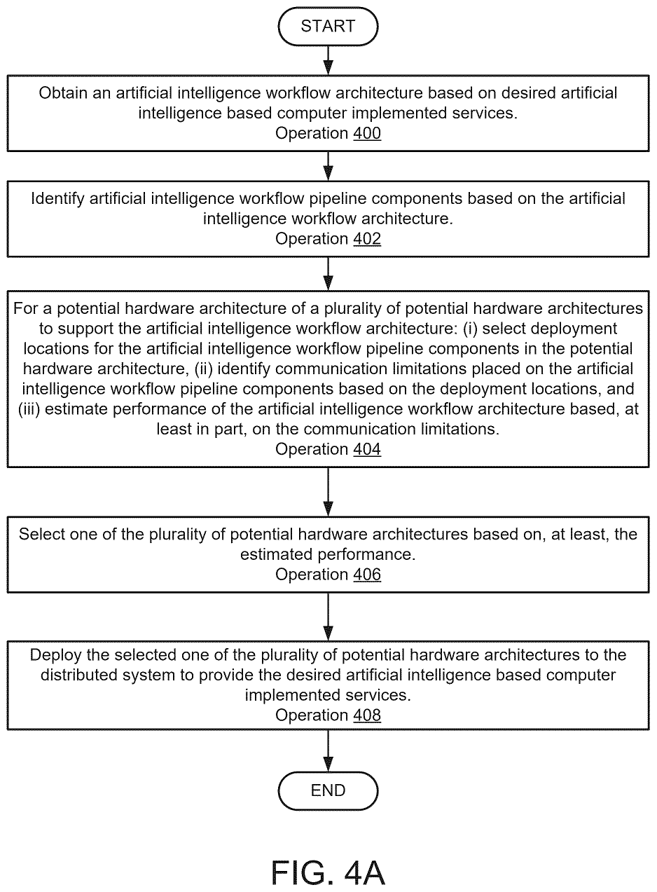

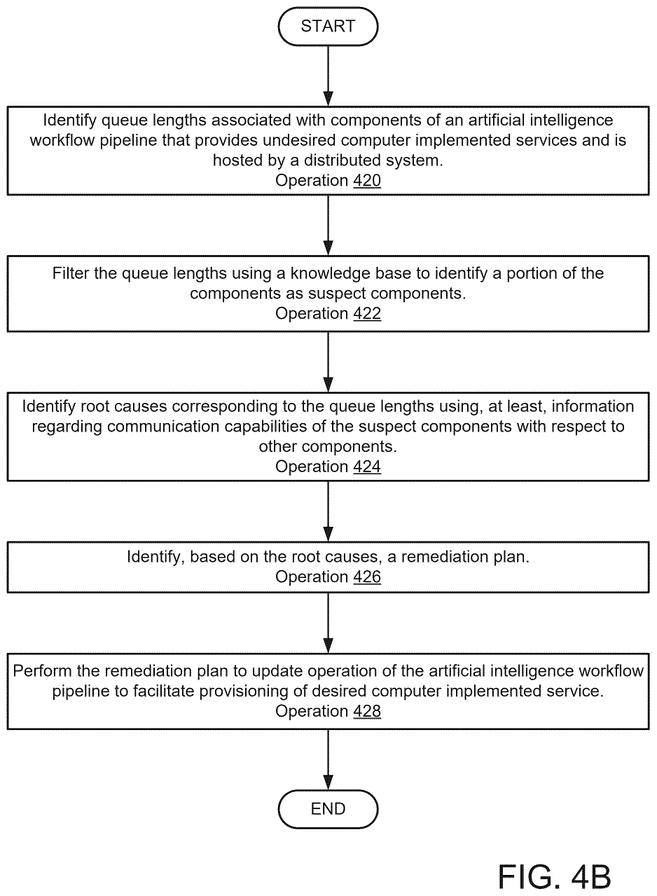

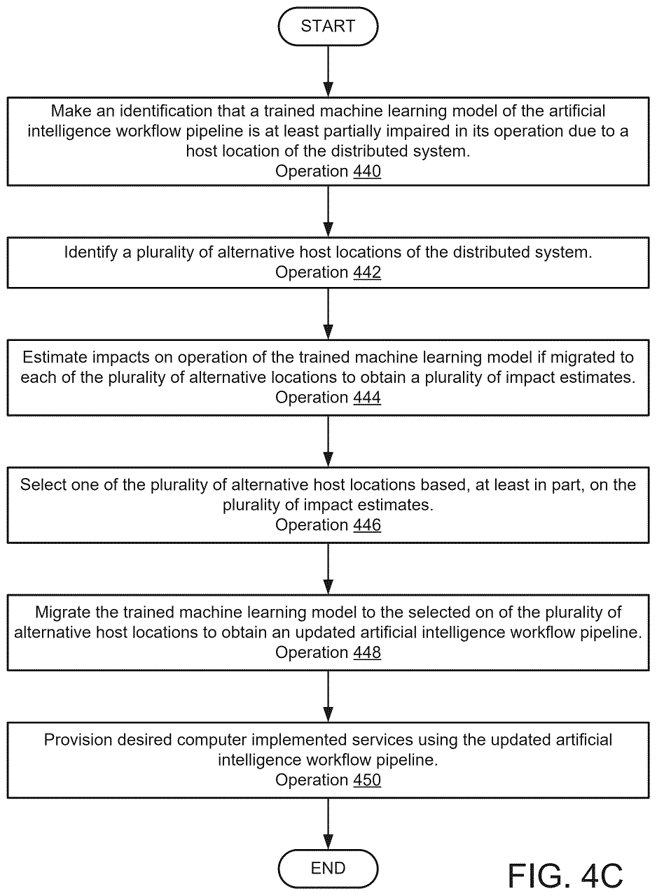

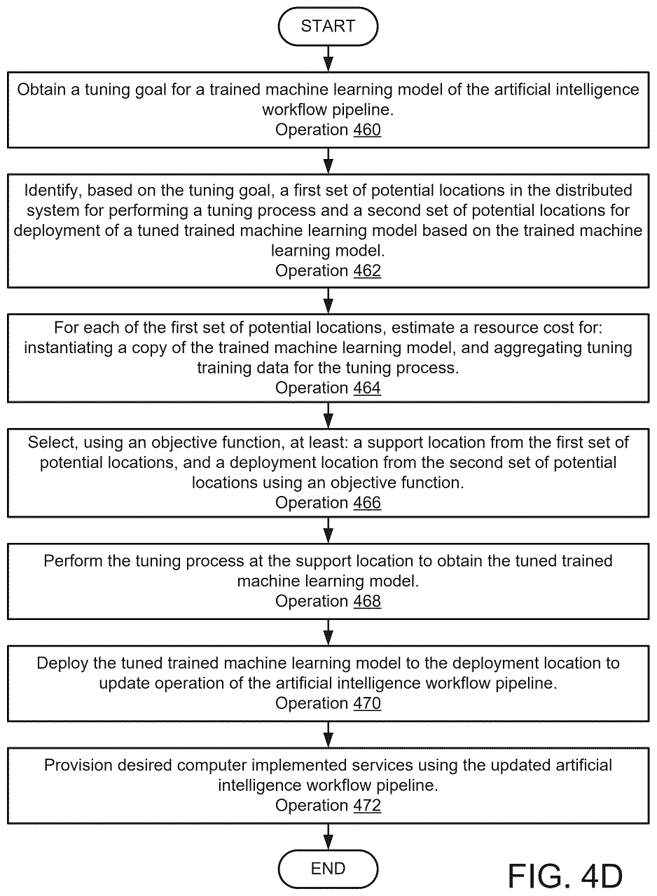

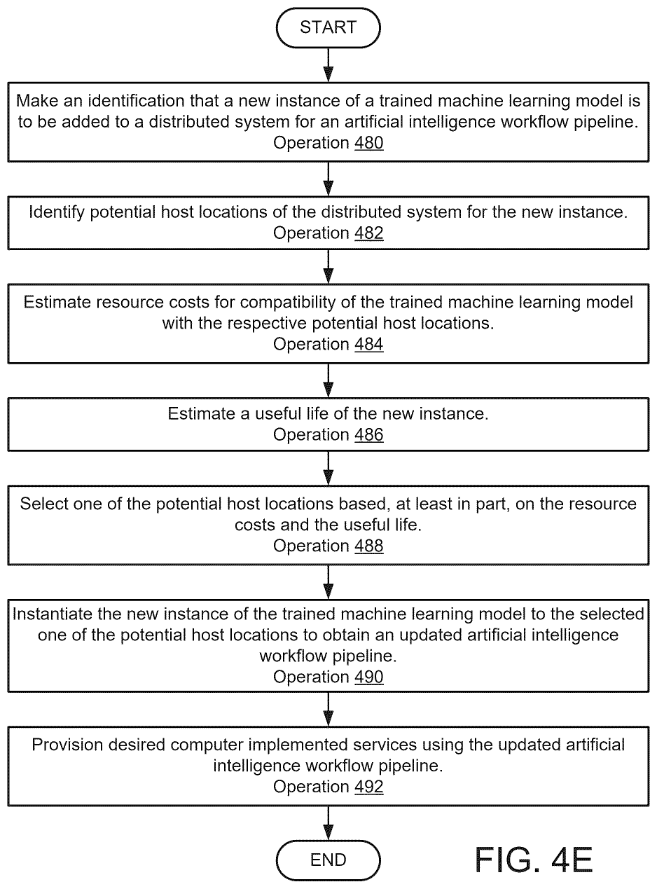

As discussed above, the components of FIG. 1 may perform various methods to manage the operation of managed systems to provide desired computer implemented services. FIGS. 4A-4E illustrate methods that may be performed by the components of the system of FIG. 1. In the diagrams discussed below and shown in FIGS. 4A-4E, any of the operations may be repeated, performed in different orders, and/or performed in parallel with or in a partially overlapping in time manner with other operations.

Turning to FIG. 4A, a first flow diagram illustrating a method for managing operation of a managed system in accordance with an embodiment is shown. The method may be performed by any of the components of the system of FIG. 1.

At operation 400, an artificial intelligence workflow architecture that is based on desired artificial intelligence based computer implemented services is obtained. The artificial intelligence workflow architecture may be obtained by obtaining information regarding the desired artificial intelligence based computer implemented services (e.g., via a portal or other interface) and using the information to identify the artificial intelligence workflow architecture. For example, historic information regarding previously deployed artificial intelligence workflow architectures and desired artificial intelligence based computer implemented services (on which the architectures were based) may be used to identify the artificial intelligence workflow architecture.

Once identified, use levels, support levels, and model levels may be identified based on the artificial intelligence workflow architecture and/or the information regarding the desired use of the artificial intelligence based computer implemented services. The aforementioned levels may be identified, for example, based on historic information, based on analytical models regarding such use, support, and models, and/or via other methods (e.g., trained inference models may be used).

At operation 402, artificial intelligence workflow pipeline components may be identified based on the artificial intelligence workflow architecture. The types of the artificial intelligence workflow pipeline components may be identified, for example, based on the support level and model level. The number of each type may be selected based on the use level for the artificial intelligence based computer implemented services.

For example, to identify the components, a use level for the desired artificial intelligence based computer implemented services, a support level for the desired artificial intelligence based computer implemented services, and a model level for the desired artificial intelligence based computer implemented services may be identified.

The use level may be a quantification of, at least, an expected frequency of use of the desired artificial intelligence based computer implemented services.

The support level may be based on services (e.g., prompt templating, retrieval augmented generation, reinforced learning, model distillation, etc.) that will support operation of an inferencing component of the artificial intelligence workflow architecture.

The model level may be a quantification of a size of an inferencing component of the artificial intelligence workflow architecture.

At operation 404, for a potential hardware architecture of a plurality of potential hardware architectures to support the artificial intelligence workflow architecture: (i) deployment locations for the artificial intelligence workflow pipeline components in the potential hardware architecture may be selected, (ii) communication limitations placed on the artificial intelligence workflow pipeline components based on the deployment locations may be identified, and (iii) performance of the artificial intelligence workflow architecture may be estimated based, at least in part, on the communication limitations

The deployment locations may be selected based on, for example, subject matter expert rules, historic information regarding previously deployed artificial intelligence workflow architectures, and/or other methods.

The communication limits may be identified by, for a data processing system of the potential hardware architecture: identifying a communication bus connecting a processor of the data processing system serving as a first deployment location of the deployment locations, a storage device serving as a second deployment location of the deployment locations, and a special purpose hardware component serving as a third deployment location of the deployment locations; and estimating limits imposed on operation of a portion of the artificial intelligence workflow pipeline components when positioned at the first deployment location, the second deployment location, and the third deployment location.

The limits imposed on operation of a portion of the artificial intelligence workflow pipeline components may be estimated by (i) applying subject matter expert defined rules, (ii) using analytical approaches, and/or (iii) via testing through test workload deployment to similar systems. The limits may be reductions in the throughput rates of the portion of the artificial intelligence workflow pipeline components from a nominal rate based on the host hardware.

The performance of the artificial intelligence workflow architecture based, at least in part, on the communication limitations may be estimated using analytical approaches, subject matter expert defined rules, testing of similar systems (e.g., active or historical), and/or via other methods.

The aforementioned process may be repeated for any number of potential hardware architectures to discriminate acceptable from unacceptable hardware architectures. In other words, potential hardware architectures that are estimated to have reduced performance may be eliminated as candidates, and/or the potential hardware architectures may be rank ordered based on the estimated performance.

At operation 406, one of the plurality of potential hardware architectures may be selected based on, at least, the estimated performance. The best ranked potential hardware architecture may be selected.

At operation 408, the selected one of the plurality of potential hardware architectures may be deployed to the distributed system to provide the desired artificial intelligence based computer implemented services. The selected one may be deployed by (i) allocating existing components of the distributed system for the desired artificial intelligence based computer implemented services, (ii) adding and allocating new components to the distributed system for the desired artificial intelligence based computer implemented services, and (iii) instantiating the components of the artificial intelligence workflow pipeline components to the allocated components of the distributed system.

The method may end following operation 408.

Turning to FIG. 4B, a second flow diagram illustrating a method for managing operation of a managed system in accordance with an embodiment is shown. The method may be performed by any of the components of the system of FIG. 1.

At operation 420, queue lengths associated with components of an artificial intelligence workflow pipeline that provides undesired computer implemented services is identified. The artificial intelligence workflow pipeline may be hosted by a distributed system. The queue lengths may be for queues that queue service requests for components of the artificial intelligence workflow pipeline. The queue lengths may be obtained by reading them from storage, receiving them from another device, generating them (e.g., based on received telemetry data for the artificial intelligence workflow pipeline), and/or via other methods.

At operation 422, the queue lengths may be filtered using a knowledge base to identify a portion of the components as suspect components. The queue lengths may be filtered by comparing the queue lengths to typical queue lengths indicated by the knowledge base for similar artificial intelligence workflow pipelines. If the queue lengths exceed (or are otherwise anomalous with respect to) the typical queue lengths, then the components to the queues having the queue lengths that exceeded the typical queue lengths may be added to the suspect components.

At operation 424, root causes corresponding to the queue lengths are identified using, at least, information regarding communication capabilities of the suspect components with respect to other components (e.g., of the artificial intelligence workflow pipeline). The root causes may be identified, for each suspect component, by (i) identifying host hardware components, (ii) identifying relationships between the component and other components, (iii) identifying other hardware components hosting the other components, (iv) identifying communication capabilities between the hardware component and the other hardware components, and (v) identifying any data access limits (e.g., read/write issues) for the other hardware components. The communication capabilities and data access limits may be analyzed to identify whether they are impacting the ability of the other components to cooperate with the component thereby causing the corresponding one of the queue lengths for the respective suspect component to be of a length that is atypical for the suspect component.

At operation 426, a remediation plan may be identified based on the root causes. The remediation plan may be identified, as discussed above, using an optimization process to evaluate potential remediations for each of the identified root causes. The objective function may be used to select one of the potential remediation for each of the identified root causes. The selected potential remediations may be aggregated as the remediation plan.

For example, as discussed above, the remediation plan may include migrating query systems (e.g., executing portions of retrieval augmented generation components), data sources (e.g., used by the retrieval augmented generation components, may serve as source of truth data sources for contextual information for prompts), etc. Likewise, the remediation plan may include replicating data sources. Further, the remediation plan may include migrating inferencing components such as trained machine learning models or prompt pre-processors. Migrating/replicating may be within a data processing system, or between data processing systems. The remediation plan may also include adding new hardware components (e.g., which may serve as migration/replication targets for existing components).

The specific selection included in the remediation plan may be guided by criteria that prioritizes different aspects of operation of the distributed system such as, for example, performance (e.g., time to completion), operating cost, reliability, etc. Thus, the use of an optimization process in selecting the actions to be performed in the remediation plan may enable customization of the remediation plan for a broad variety of use cases.

At operation 428, the remediation plan may be performed to update operation of the artificial intelligence workflow pipeline to facilitate provisioning of desired computer implemented services. In contrast to the undesired computer implemented services, the desired computer implemented services may be more likely to meet goal/expectations of the operator by mitigating communication and/or data access bottlenecks in the distributed system.

The method may end following operation 428.

Turning to FIG. 4C, a third flow diagram illustrating a method for managing operation of a managed system in accordance with an embodiment is shown. The method may be performed by any of the components of the system of FIG. 1.

At operation 440, an identification that a trained machine learning model of an artificial intelligence workflow pipeline is at least partially impaired in its operation due to a host location of the distributed system is made. The artificial intelligence workflow pipeline may be hosted by a distributed system. The identification may be made, for example, via operations 420-422. The trained machine learning model may be one of the suspect components as described with respect to FIG. 4B.

At operation 442, a plurality of alternative host locations of the distributed system may be identified. The plurality of alternative host locations of the distributed system may be identified by (i) identifying resources for operation of the trained machine learning model, (ii) identifying potential modifications for reducing the resources for operation of the trained machine learning model, and (iii) searching the distributed systems for locations that meet that have the resources and/or reduced resources. For example, a list of locations within the distributed system (and/or information regarding the model full/reduced that may be hosted at the corresponding locations). The plurality of alternative host locations may also be obtained by filtering the locations based on minimum communication capability requirements, minimum data access requirements, etc. so that the plurality of alternative host locations are unlikely to be impaired due to bottlenecks. For example, the trained machine learning model may be impaired due to any of communication latency between an upstream component of the artificial intelligence workflow pipeline and the trained machine learning model; and latency between the upstream component of the artificial intelligence workflow pipeline and a storage resource in which data is stored and used in operation of the upstream component.

At operation 444, impacts on operation of the trained machine learning model if migrated to each of the plurality of alternative locations is estimated to obtain a plurality of impact estimates. The plurality of impacts estimates may be obtained by, for one of the alternative locations, identifying computing resources available at the alternative host location; identifying a change to the trained machine learning model necessary for the trained machine learning model to operate at the alternative host location; and identifying a change in capability of the trained machine learning model if the change is made to the trained machine learning model.

The change in the capability may be identified, for example, by distilling an instance of the trained machine learning model to a reduced size for compatibility with the computing resources to obtain a distilled trained machine learning model; and evaluating information content of the distilled trained machine learning model to identify the change in the capability. The information content may be evaluated by, for example, extracting at least one relationship from the distilled trained machine learning model; and comparing the at least one relationship to at least one complementary relationship present in training data used to obtain the trained machine learning model to identify the change in the capability.

At operation 446, one of the plurality of alternative host locations is selected based, at least in part, on the plurality of impact estimates. The one may be selected using an objective function to obtain quantifications for the plurality of alternative host locations, rank order the alternative host locations, and select the best ranked one of the ranked alternative host locations.

At operation 448, the trained machine learning model may be migrated to the selected one of the plurality of alternative host locations to obtain an updated artificial intelligence workflow pipeline. The model may be migrated by instantiating a new instance of the trained model at the selected one of the plurality of alternative host locations. The new instance may, if necessary based on the resources available in the selected alternative host location, be a reduced size version as discussed with respect to operation 440.

At operation 450, desired computer implemented services may be provisioned using the updated artificial intelligence workflow pipeline through generation of inferences using the updated pipeline.

The method may end following operation 450.

While described with respect to a trained machine learning model, other components of the artificial intelligence workflow pipeline may be similarly migrated.

Turning to FIG. 4D, a fourth flow diagram illustrating a method for managing operation of a managed system in accordance with an embodiment is shown. The method may be performed by any of the components of the system of FIG. 1.

At operation 460, a tuning goal for a trained machine learning model of an artificial intelligence workflow pipeline may be obtained. The goal may be obtained by analyzing feedback regarding inferences generated by the workflow pipeline. For example, the feedback may be used to determine that existing inferences provided by the trained machine learning model are not desirable to at least a portion of downstream users. The tuning goal may be to provide inferences of a different type than that provided by the trained machine learning model, and that may be desired by the portion of the downstream users.

At operation 462, based on the tuning goal, a first set of potential locations in the distributed system for performing a tuning process and a second set of potential locations for deployment of a tuned trained machine learning model (e.g., that is based on the trained machine learning model) may be identified. The aforementioned locations may be identified by estimating resources for training and inferencing, and filtering the distributed system based on the estimated resources (e.g., and/or other criteria).

At operation 464, for each of the first set of potential locations, estimations may be obtained for resource costs for (i) instantiating a copy of the trained machine learning model, and (ii) aggregating tuning training data for the tuning process. The resource cost for instantiating the copy may be obtained by identifying a transit path for the trained machine learning model and analyzing the transit path to estimate the resource cost. The resource cost for aggregating the tuning training data may be estimated by identifying locations of portions of the tuning training data, identifying transit paths between the locations and the respective location in the first set of potential locations, and analyzing the transit paths to estimate the resource cost.

At operation 466, using an objective function, a selection process may be performed to select at least (i) a support location from the first set of potential locations, and (ii) a deployment location from the second set of potential locations. The selection process may use an objective function. The objective function may be used to rank order sets made up of locations from the first and second sets of locations. The locations from the best rank ordered set may be used as the support location (e.g., the location from the best rank ordered set that is a member of the first set) and the deployment location (e.g., the location from the best rank ordered set that is a member of the second set).

At operation 468, the tuning process may be performed at the support location to obtain the tuned trained machine learning model. The tuning process may be performed by (i) copying the trained machine learning model to the support location, (ii) making one or more modifications to the model (e.g., adding layers, resetting weights, etc.) to obtain a modified model, and (iii) training the modified model at the support location using the aggregated tuning data to obtain the tuned trained machine learning model.

The tuning training data may define a relationship between at least a portion of features on which the trained machine learning model operates (e.g., may relate input A to output B) and a quantity that is desired by the downstream consumer (e.g., may be C, the tuning data may relate input A to output C). The tuning training data may be based on the tuning goal.

At operation 470, the tuned trained machine learning model may be deployed to the deployment location to update operation of the artificial intelligence workflow pipeline.

At operation 472, desired computer implemented services may be provisioned using the updated artificial intelligence workflow pipeline.

The method may end following operation 472.

Turning to FIG. 4D, a fourth flow diagram illustrating a method for managing operation of a managed system in accordance with an embodiment is shown. The method may be performed by any of the components of the system of FIG. 1.

At operation 480, an identification that a new instance of a trained machine learning model is to be added to a distributed system for an artificial intelligence workflow pipeline may be made. The identification may be made, for example, based on undesired operation of an existing instance of the trained machine learning model, a lack of utility of inferences generated by the existing instance and a desired for other types of inferences to be generated, etc. The identification may be made through automated analysis of the artificial intelligence workflow pipeline, through analysis of feedback from downstream consumers of inferences from the artificial intelligence workflow pipeline, and/or via other methods.

At operation 482, potential host locations of the distributed system for the new instance may be identified. The potential host locations may be identified by filtering the distributed system based on resource availabilities with respect to estimated resources necessary to host the new instance. The resulting potential host locations may, therefore, have sufficient free resources to host the new instance.

At operation 484, resource costs for compatibility of the trained machine learning model with the respective host locations are estimated. The resource costs may be estimated, for example, by identifying changes to the trained machine learning model needed to be within the resources available at the respective potential host locations. For example, if the trained machine learning model is larger than available resources as a given host location, then the trained machine learning model may need to be reduced in size through, for example, distillation. The computation cost for reducing the size of the model, changing the model architecture, and/or otherwise modifying the trained machine learning model for each potential host location may be estimated. The estimations may take into account processing costs (e.g., making the changes), data transit costs to make the changes (e.g., aggregating training data at particular locations, using intermediate locations for training), and/or other costs. The estimations may be complete analytically, through comparison to historic records of such processes, and/or via other methods.

At operation 486, a useful life of the new instance is estimated. The useful life may be estimated by, for example, identifying useful lives of similar models in the past. The similarity may be based on, for example, model architecture types, inference types (e.g., information content of the generated inferences), input data types (e.g., data used in generating the inferences), and/or other basis. The historic lives of other trained machine learning models deemed to be similar to the new instance may be used to estimate the useful life of the new instance.

At operation 488, one of the potential host locations may be selected based, at least in part, on the resource costs and the useful life. The selection may be made using an objective function. The objective function may generally penalize resource costs for compatibility inversely to useful life. For example, for a longer estimated useful life, the objective function may generally be insensitive to resource costs for compatibility. However, as the estimated useful life decreases, the objective function may indicate that potential host locations requiring modifications with higher resource costs for compatibility are less desirable.

The objective function may also take into account, for example, resource costs for transferring data to the potential host locations (e.g., may generally discourage such costs).

The objective function may be usable to rank order the potential host locations. A best ranked host location may be selected.

At operation 490, the new instance of the trained machine learning model to the selected one of the potential host locations may be instantiated to obtain an updated artificial intelligence workflow pipeline. The new instance may be obtained by, for example, making any compatibility changes to the trained machine learning model (e.g., distillation, updating, etc.), copying the changed trained machine learning model to the selected one of the potential host locations, and initiating execution of the changed trained machine learning model.

At operation 492, desired computer implemented services using the updated artificial intelligence workflow pipeline may be provided.

The method may end following operation 492.

Thus, using the methods shown in FIGS. 4A-4E, embodiments disclosed herein may facilitate deployment of artificial intelligence workflow pipelines, monitoring, and management of the deployed artificial intelligence workflow pipelines to proactively address bottlenecks that may negatively impact performance of the artificial intelligence workflow pipelines.

Any of the components illustrated in FIGS. 1-3D may be implemented with one or more computing devices. Turning to FIG. 5, a block diagram illustrating an example of a data processing system (e.g., a computing device) in accordance with an embodiment is shown. For example, system 500 may represent any of the data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high-level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random-access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a distributed system hosting an artificial intelligence workflow pipeline, the method comprising:
making an identification that a new instance of a trained machine learning model is to be added to the distributed system for the artificial intelligence workflow pipeline;
identifying potential host locations of the distributed system for the new instance;
estimating resource costs for compatibility of the trained machine learning model with the respective potential host locations;
estimating a useful life of the new instance;
selecting one of the potential host locations based, at least in part, on the resource costs and the useful life;
instantiating the new instance of the trained machine learning model to the selected one of the potential host locations to obtain an updated artificial intelligence workflow pipeline; and
provisioning desired computer implemented services using the updated artificial intelligence workflow pipeline.

2. The method of claim 1, wherein the one of the potential host locations is selected using, at least in part, an objective function that takes into account the resource costs and the useful life.

3. The method of claim 2, wherein the objective function is usable to rank order the potential host locations.

4. The method of claim 3, wherein the objective function penalizes resource costs inversely to the useful life.

5. The method of claim 1, wherein the resource costs for compatibility of the trained machine learning model is based modification costs for the trained machine learning model to be within resource availabilities of the potential host locations.

6. The method of claim 5, wherein the modification costs comprise resource expenditures for distilling of the trained machine learning model to obtain a reduced size version.

7. The method of claim 6, wherein the expenditures comprise first resources for generating synthetic training data and second resource costs for training a new machine learning model using, at least, the synthetic training data.

8. The method of claim 1, wherein the useful life is based on historic information regarding durations of time other trained machine learning models that are similar to the trained machine learning model remained in the artificial intelligence workflow pipeline.

9. The method of claim 8, wherein the other trained machine learning models are deemed similar to the trained machine learning model based on a common architecture.

10. The method of claim 8, wherein the other trained machine learning models are deemed similar to the trained machine learning model based on a common inference type.

11. A non-transitory machine-readable medium having instructions stored therein, which when executed by a processor, cause operations for managing a distributed system hosting an artificial intelligence workflow pipeline to be performed, the operations comprising:
making an identification that a new instance of a trained machine learning model is to be added to the distributed system for the artificial intelligence workflow pipeline;
identifying potential host locations of the distributed system for the new instance;
estimating resource costs for compatibility of the trained machine learning model with the respective potential host locations;
estimating a useful life of the new instance;
selecting one of the potential host locations based, at least in part, on the resource costs and the useful life;
instantiating the new instance of the trained machine learning model to the selected one of the potential host locations to obtain an updated artificial intelligence workflow pipeline; and
provisioning desired computer implemented services using the updated artificial intelligence workflow pipeline.

12. The non-transitory machine-readable medium of claim 11, wherein the one of the potential host locations is selected using, at least in part, an objective function that takes into account the resource costs and the useful life.

13. The non-transitory machine-readable medium of claim 12, wherein the objective function is usable to rank order the potential host locations.

14. The non-transitory machine-readable medium of claim 13, wherein the objective function penalizes resource costs inversely to the useful life.

15. The non-transitory machine-readable medium of claim 11, wherein the resource costs for compatibility of the trained machine learning model is based modification costs for the trained machine learning model to be within resource availabilities of the potential host locations.

16. A system, comprising:
a processor; and
a memory coupled to the processor to store instructions, which when executed by the processor, cause operations for managing a distributed system hosting an artificial intelligence workflow pipeline to be performed, the operations comprising:
making an identification that a new instance of a trained machine learning model is to be added to the distributed system for the artificial intelligence workflow pipeline;
identifying potential host locations of the distributed system for the new instance;
estimating resource costs for compatibility of the trained machine learning model with the respective potential host locations;
estimating a useful life of the new instance;
selecting one of the potential host locations based, at least in part, on the resource costs and the useful life;
instantiating the new instance of the trained machine learning model to the selected one of the potential host locations to obtain an updated artificial intelligence workflow pipeline; and
provisioning desired computer implemented services using the updated artificial intelligence workflow pipeline.

17. The system of claim 16, wherein the one of the potential host locations is selected using, at least in part, an objective function that takes into account the resource costs and the useful life.

18. The system of claim 17, wherein the objective function is usable to rank order the potential host locations.

19. The system of claim 18, wherein the objective function penalizes resource costs inversely to the useful life.

20. The system of claim 16, wherein the resource costs for compatibility of the trained machine learning model is based modification costs for the trained machine learning model to be within resource availabilities of the potential host locations.
